(19) United States
(12) Patent Application Publication
(10) Pub. No.: US 2026/0233512 A1
(43) Pub. Date: Aug. 13, 2026

(54) PRINT DEVICE, TRANSPORT DEVICE, PINCH ROLLER, PRINT SYSTEM, AND TRANSPORT METHOD

(71) Applicant: MIMAKI ENGINEERING CO., LTD., Nagano (JP)

(72) Inventors: Soichiro Takehana, Nagano (JP); Ryuta Harayama, Nagano (JP)

(73) Assignee: MIMAKI ENGINEERING CO., LTD., Nagano (JP)

(21) Appl. No.: 19/156,389

(22) PCT Filed: Jan. 29, 2024
(86) PCT No.: PCT/JP2024/002540

§ 371 Date: Aug. 13, 2025

(30) Foreign Application Priority Data
Feb. 21, 2023 (JP) 2023-025601
Feb. 21, 2023 (JP) 2023-025602

(51) Int. Cl. B41J 2/005; B41J 3/407; B41J 11/00; D06P 5/24; D06P 5/30

(52) U.S. Cl. CPC B41J 2/0057; B41J 3/4078; B41J 11/0015; D06P 5/003; D06P 5/30

(57) ABSTRACT

The present invention realizes appropriate transfer printing. A transport roller 61 rotates in contact with a film layer of a transfer sheet 500 including a receiving layer that receives the transfer ink, a peeling layer that joins the receiving layer and a film layer in a peelable manner, and the film layer that supports the receiving layer via the peeling layer. A pinch roller 62 clamps the transfer sheet 500 together with the transport roller 61, and rotates in contact with the receiving layer of the transfer sheet 500. A portion of the pinch roller 62 that contacts the receiving layer is formed of a low-adhesion material that is less likely to adhere to the receiving layer than the peeling layer is.

### TECHNICAL FIELD

The present disclosure relates to a print device, transport device, pinch roller, print system, and transport method.

### BACKGROUND ART

Currently, a technique for printing on a fabric using transfer printing is known. The transfer printing is a printing method in which an image is drawn on a transfer sheet with transfer ink, and the image drawn on the transfer sheet is transferred to a fabric.

For example, Patent Literature 1 describes a print device in which a transfer image is printed on a transfer film that is a transfer sheet, and a transfer body and the transfer film on which the transfer image is printed are layered and the transfer film is bonded to the transfer body. In such a print device, for example, the transfer sheet is clamped between a transport roller and a pinch roller, and the transport roller is rotated to transport the transfer sheet.

In addition, currently known is a processing device that pulls out a medium from a roll body around which the medium is wound in a roll shape, and a processor performs various types of processes on the pulled-out medium. For example, there is known a print device in which a print medium is pulled out from a roll body around which the print medium is wound in a roll shape, and a printing unit prints an image on the pulled-out print medium. Such a processing device generally incorporates a transport device that pulls out a medium from a roll body and transports the pulled-out medium to a processor by a transport roller.

Here, if the roll body is distorted or the diameter of the roll body changes due to the use of the medium, the tension applied to the portion between the roll body and the transport roller in the medium may change. When the tension of this portion changes, defects such as variations in transport speed, skew, and floating of the medium on the platen may occur, and appropriate processes may not be executed on the medium. In order to suppress the occurrence of such problems, it is preferable to devise a method of unwinding the medium, a method of transporting the medium, and the like. For example, Patent Literature 2 describes a technique of loosening a recording medium when the recording medium is transported using an upstream roller on a transport path and a downstream roller on the transport path.

### CITATION LIST

### Patent Literature

Patent Literature 1: Japanese Unexamined Patent Publication No. 2022-130110
Patent Literature 2: Japanese Unexamined Patent Publication No. 2008-105436

### SUMMARY OF INVENTION

### Technical Problems

However, on the surface of the transfer sheet used in transfer printing, an easily adhesive receiving layer for receiving the transfer ink is provided. For this reason, for example, when the transfer sheet is transported, the receiving layer of the transfer sheet adheres to the surface of the pinch roller, unevenness occurs on the surface of the transfer sheet, and there is a problem that appropriate transfer printing cannot be performed. Patent Literature 1 does not describe a method for solving such a problem. Therefore, a technique for realizing appropriate transfer printing is desired.

The present disclosure has been made in view of the above problems, and an object thereof is to provide a print device, a transport device, a pinch roller, and a print system that realize appropriate transfer printing.

In addition, the technique described in Patent Literature 2 is a technique for slackening a portion between an upstream roller and a downstream roller in a recording medium, and is not a technique for loosening a portion between a roll body and an upstream roller in a recording medium. For this reason, in the technique described in Patent Literature 2, it is difficult to suppress a change in tension applied to a portion of the medium between the roll body and the transport roller, and it is difficult to suppress the occurrence of the above-described defect. Therefore, a technique for appropriately unwinding and transporting the medium from the roll body is desired.

The present disclosure has been made in view of the above problems, and an object thereof is to provide a transport device, a print device, and a transport method for appropriately unwinding and transporting a medium from a roll body.

### Solutions to Problems

In order to achieve the above object, a print device according to a first aspect of the present disclosure is:
a print device that prints an image with transfer ink on a transfer sheet including a receiving layer that receives the transfer ink, a peeling layer that joins the receiving layer and a film layer in a peelable manner, and the film layer that supports the receiving layer via the peeling layer, the print device comprising:
a transport roller that rotates in contact with the film layer of the transfer sheet;
a pinch roller that clamps the transfer sheet together with the transport roller, and rotates in contact with the receiving layer of the transfer sheet; and
a printing unit that prints an image with the transfer ink on the transfer sheet transported by the transport roller and the pinch roller; wherein
a portion of the pinch roller that contacts the receiving layer is formed of a low-adhesion material that is less likely to adhere to the receiving layer than the peeling layer is.

The low-adhesion material may be at least one selected from a fluorine-containing compound, a silicon-containing compound, and an oil-containing polyoxymethylene (POM).

The printing unit may include an inkjet head.

In order to achieve the above object, a transport device according to a second aspect of the present disclosure is:
a transport device that transports a transfer sheet including a receiving layer that receives transfer ink, a peeling layer that joins the receiving layer and a film layer in a peelable manner, and the film layer that supports the receiving layer via the peeling layer,
the transport device comprising:
a transport roller that rotates in contact with the film layer of the transfer sheet; and
a pinch roller that clamps the transfer sheet together with the transport roller, and rotates in contact with the receiving layer of the transfer sheet; wherein
a portion of the pinch roller that contacts the receiving layer is formed of a low-adhesion material that is less likely to adhere to the receiving layer than the peeling layer is.

In order to achieve the above object, a pinch roller according to a third aspect of the present disclosure is,
a pinch roller that is used for a transport device that transports a transfer sheet including a receiving layer that receives transfer ink, a peeling layer that joins the receiving layer and a film layer in a peelable manner, and the film layer that supports the receiving layer via the peeling layer, the pinch roller comprising
clamping the transfer sheet together with the transport roller, and rotating in contact with the receiving layer of the transfer sheet, wherein
a portion that contacts the receiving layer is formed of a low-adhesion material that is less likely to adhere to the receiving layer than the peeling layer is.

In order to achieve the above object, a print system according to a fourth aspect of the present disclosure is:
a print system that executes transfer printing using a transfer sheet including a receiving layer that receives transfer ink, a peeling layer that joins the receiving layer and a film layer in a peelable manner, and the film layer that supports the receiving layer via the peeling layer, the print system comprising:
a print device that prints an image with the transfer ink on the transfer sheet;
a powder applicator that applies an adhesive powder to the transfer sheet on which the image is printed by the print device; and
a transfer device that transfers the image drawn on the transfer sheet to which the adhesive powder is applied by the powder applicator onto a transfer target medium; wherein
the print device includes
a transport roller that rotates in contact with the film layer of the transfer sheet, and
a pinch roller that clamps the transfer sheet together with the transport roller, and rotates in contact with the receiving layer of the transfer sheet, and
a portion of the pinch roller that contacts the receiving layer is formed of a low-adhesion material that is less likely to adhere to the receiving layer than the peeling layer is.

In order to achieve the above object, a transport device according to a fifth aspect of the present disclosure comprises:
a rotary mechanism configured to support a roll body around which a medium is wound in a roll shape such that a central axis of the roll body is horizontal, and rotate the roll body about the central axis;
a controller that controls the rotary mechanism to rotate the roll body in a direction in which the medium is unwound from the roll body; and
a transport mechanism configured to transport the medium unwound from the roll body toward a downstream side of a transport path, wherein
the controller controls the rotary mechanism so as to maintain a state in which the medium unwound from roll body is slackened by its own weight.

The controller may rotate the roll body in a direction in which the medium is unwound from the roll body during transport of the medium by the transport mechanism.

Being provided with a measuring unit that measures a slack amount of the medium slackened by its own weight,
the controller may rotate the roll body in a direction in which the medium is unwound from the roll body when the slack amount measured by the measuring unit is smaller than a reference amount.

The medium may be a transfer sheet including a receiving layer that receives transfer ink, a peeling layer that joins the receiving layer and a film layer in a peelable manner, and the film layer that supports the receiving layer via the peeling layer.

In order to achieve the above object, a print device according to a sixth aspect of the present disclosure comprises:
the transport device; and
an ejection head that ejects ink onto the medium transported by the transport device.

In order to achieve the above object, a transport method according to a seventh aspect of the present disclosure comprises:
supporting a roll body around which a medium is wound in a roll shape such that a central axis of the roll body is horizontal;
rotating the roll body about the central axis in a direction in which the medium is unwound from the roll body;
transporting the medium unwound from the roll body toward a downstream side of a transport path; and
rotating the roll body so as to maintain a state in which the medium unwound from the roll body is slackened by its own weight.

### Effect of the Invention

According to the present disclosure, appropriate transfer printing can be realized. Furthermore, according to the present disclosure, the medium can be unwound from the roll body and transported appropriately.

### BRIEF DESCRIPTION OF THE DRAWINGS

FIG. 1 is a configuration diagram of a print system according to an embodiment of the present disclosure.

FIG. 2 is an explanatory view of transfer printing.

FIG. 3 is a configuration diagram of the print device according to the embodiment of the present disclosure.

FIG. 4 is an external view of the print device according to the embodiment of the present disclosure.

FIG. 5 is a side view of the print device according to the embodiment of the present disclosure.

FIG. 6 is a side view of a sheet clamping unit of the print device according to the embodiment of the present disclosure.

FIG. 7 is a perspective view of a sheet clamping unit of the print device according to the embodiment of the present disclosure.

FIG. 8 is a view illustrating a state in which the receiving layer of the transfer sheet is peeled off.

FIG. 9 is a configuration diagram of a printing system according to Embodiment 1.

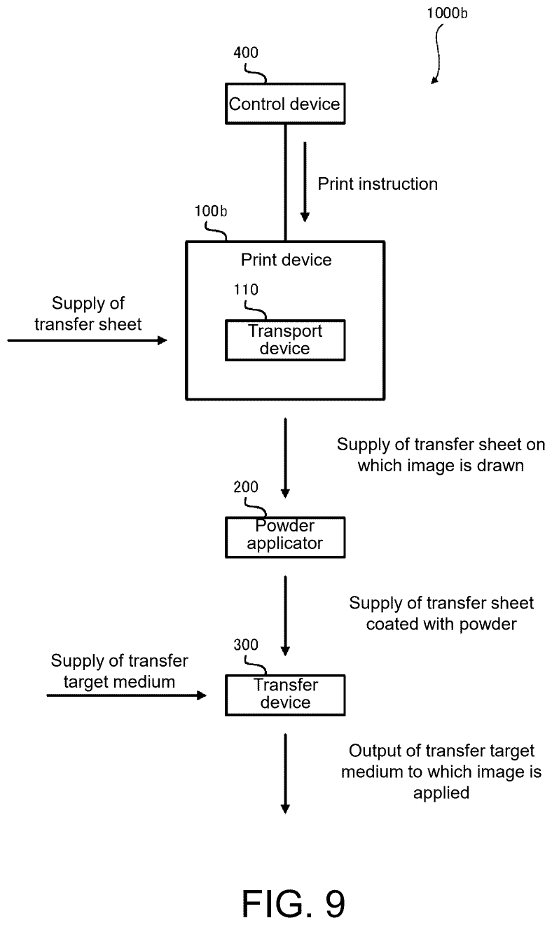

FIG. 10 is an explanatory view of transfer printing.

FIG. 11 is a configuration diagram of a print device according to Another embodiment 1.

FIG. 12 is an external view of the print device according to Another embodiment 1.

FIG. 13 is a side view of the print device according to Another embodiment 1.

FIG. 14 is a first explanatory diagram of an operation of a transport device according to Another embodiment 1.

FIG. 15 is a second explanatory diagram of the operation of the transport device according to Another embodiment 1.

FIG. 16 is a flowchart illustrating a rotation control process executed by the transport device according to Another embodiment 1.

FIG. 17 is an explanatory diagram of an operation of a transport device according to Another embodiment 2.

### DESCRIPTION OF EMBODIMENT

### Embodiment

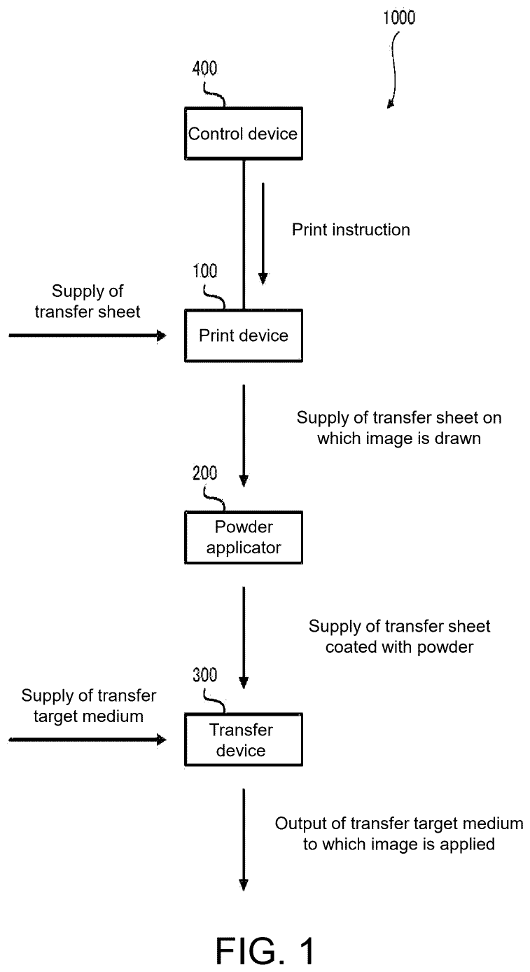

First, a configuration of a print system 1000 according to an embodiment of the present disclosure will be described with reference to FIG. 1. The print system 1000 is a system that forms an image on a transfer target medium by transfer printing using a transfer sheet. The transfer printing is a printing method in which an image is not directly printed on a transfer target medium which is a medium to be printed, but an image is applied to the transfer target medium by transfer using a transfer sheet. In transfer printing, an image is printed in advance on a transfer sheet with the transfer ink, and heat and pressure are applied to the transfer sheet layered on a transfer target medium to attach the image to the transfer target medium.

The transfer sheet is a sheet-like medium on which an image to be attached to a transfer target medium is printed with the transfer ink. In the present embodiment, before an image is printed, the transfer sheet is wound in a roll shape, and an image is printed on the stretched transfer sheet at the time of printing the image. The transfer target medium is a medium to be printed, and is a medium on which an image is finally formed by transfer printing. The transfer target medium is a medium that is difficult to directly print by normal printing. The transfer target medium is, for example, clothing including nylon clothing, a towel, an enamel bag, an umbrella, or the like. In the present embodiment, the transfer target medium is a T-shirt. As illustrated in FIG. 1, the print system 1000 includes a print device 100, a powder applicator 200, a transfer device 300, and a control device 400.

The print device 100 prints an image with the transfer ink on the transfer sheet under the control of the control device 400. For example, the print device 100 acquires image data from the control device 400, and specifies an image printing region that is a region on which an image is printed on the transfer sheet on the basis of the image data. The print device 100 ejects color ink for transfer corresponding to an image indicated by image data onto an image printing region on the transfer sheet. Thereafter, the print device 100 ejects white ink for transfer onto the image printing region on the transfer sheet.

The reason for layering the white ink for transfer on the color ink for transfer is to suppress the influence of the color of the fabric of the transfer target medium. Hereinafter, the color ink for transfer and the white ink for transfer will be collectively referred to as transfer ink as appropriate. As the transfer ink, a pigment ink, a UV (Ultraviolet) ink, a solvent ink, and the like can be employed. In the present embodiment, the transfer ink is a pigment ink. The print device 100 has a function of transporting a transfer sheet. Therefore, the print device 100 is an example of a transport device.

The powder applicator 200 applies the powder to the transfer sheet on which the image is printed by the print device 100. Specifically, the powder applicator 200 applies the powder to the region on the transfer sheet to which the white ink has been applied, before the applied white ink on the transfer sheet dries. This powder is an adhesive powder that exhibits adhesiveness when melted. For example, the powder applicator 200 may coat the entire surface of the transfer sheet with the powder, and cause the powder to adhere only to the region on the transfer sheet to which the white ink has been applied.

The transfer device 300 transfers the image drawn on the transfer sheet to which the powder has been applied by the powder applicator 200 to the transfer target medium. The transfer device 300 transfers the image drawn on the transfer sheet to the transfer target medium by thermal transfer. That is, the transfer device 300 applies heat and pressure to the transfer sheet layered on the transfer medium so that the surface to which the powder is applied covers the transfer target medium. Then, the powder melts and the transfer sheet and the transfer target medium adhere to each other. When the transfer sheet is peeled off from the transfer target medium after the transfer sheet and the transfer target medium are cooled, an image drawn with the transfer ink remains on the transfer target medium.

The control device 400 is a device that controls the print device 100. For example, the control device 400 transmits image data indicating an image to be drawn on the transfer sheet to the print device 100, and instructs the print device 100 to print the image. The control device 400 may transmit information specifying the number of images to be printed, the size of the image to be printed, and the like to the print device 100. The control device 400 includes a communication interface (not illustrated) for communicating with the print device 100. The control device 400 is a personal computer, a tablet terminal, a smartphone, or the like.

In the print system 1000, the application of the transfer ink by the print device 100 and the application of the powder by the powder applicator 200 are sequentially executed while the roll-shaped transfer sheet is stretched and rewound in the roll shape. In the print system 1000, the transfer sheet to which the powder has been applied by the powder applicator 200 is cut into a desired size, and the transfer device 300 performs thermal transfer on the cut transfer sheet and the transfer target medium.

The print device 100 and the powder applicator 200 may be installed in the same facility, and the print device 100 and the transfer device 300 may be installed in different facilities. For example, the print device 100 and the powder applicator 200 may be installed in a factory that manufactures a transfer sheet to which powder is applied, and the transfer device 300 may be installed in a factory that manufactures a transfer target medium to which an image is applied by transfer printing. The print device 100 and the powder applicator 200 may not be synchronized with each other and may not communicate with each other.

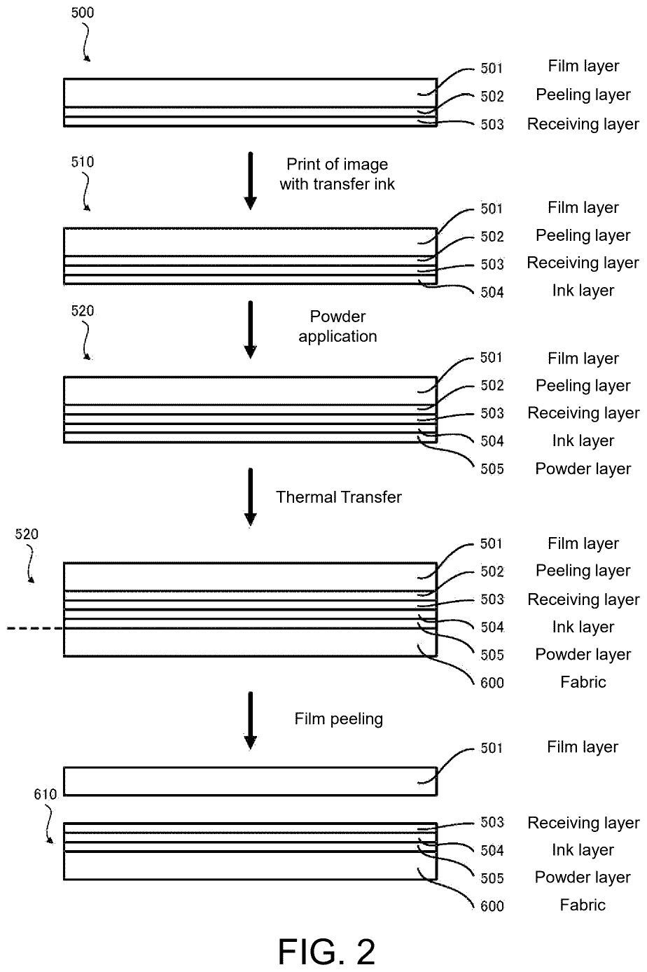

Next, transfer printing executed by the print system 1000 will be described with reference to FIG. 2.

First, the print device 100 prints an image on the transfer sheet 500 with the transfer ink. The transfer sheet 500 is a transfer sheet before being processed by the print device 100. The transfer sheet 500 includes a film layer 501, a peeling layer 502, and a receiving layer 503.

The film layer 501 is a layer that supports the receiving layer 503 via the peeling layer 502. The film layer 501 is a layer serving as a base of the receiving layer 503. The film layer 501 is, for example, a layer made of various resins.

The peeling layer 502 is a layer that joins the film layer 501 and the receiving layer 503 in a peelable manner. The peeling layer 502 is a layer for separating the film layer 501 and the receiving layer 503 when the transfer sheet 500 adhered to the transfer target medium is peeled off from the transfer target medium. The peeling layer 502 is, for example, a layer including a fluorine-based peeling agent or a silicon-based peeling agent.

The receiving layer 503 is a layer that receives the transfer ink. It is preferable that the receiving layer 503 be configured with a material and a structure exhibiting excellent adsorption properties for the transfer ink. For example, it is preferable that the receiving layer 503 be configured with a porous material. In addition, it is preferable that the receiving layer 503 be configured to include at least one of polyvinyl alcohol (PVA) and polyvinyl chloride (PVC), for example.

The print device 100 prints an image on the receiving layer 503 of the transfer sheet 500 with the color ink for transfer. Thereafter, the print device 100 applies the white ink for transfer to the region where the image is printed with the color ink for transfer on the transfer sheet 500. The print device 100 generates the transfer sheet 510 by printing an image on the transfer sheet 500 with the transfer ink.

The transfer sheet 510 includes the film layer 501, the peeling layer 502, the receiving layer 503, and an ink layer 504. The ink layer 504 is a layer containing the transfer ink. The ink layer 504 is a layer formed on the surface or inside of the receiving layer 503 by sequentially layering the color ink for transfer and the white ink for transfer with respect to the receiving layer 503.

In FIG. 2, a layer of color ink for transfer and a layer of white ink for transfer are not distinguished from each other, and are collectively shown as a single layer of transfer ink. In FIG. 2, the receiving layer 503 and the ink layer 504 are layered, but the receiving layer 503 and the ink layer 504 may be integrated.

The powder applicator 200 applies an adhesive powder to the ink layer 504 of the transfer sheet 510. The powder applicator 200 applies an adhesive powder to the transfer sheet 510 to generate the transfer sheet 520. The transfer sheet 520 includes the film layer 501, the peeling layer 502, the receiving layer 503, the ink layer 504, and a powder layer 505. The powder layer 505 is a layer formed of an adhesive powder.

The transfer device 300 thermally transfers the image drawn on the transfer sheet 520 to a fabric 600. Specifically, the transfer device 300 applies heat and pressure to the transfer sheet 520 layered on the fabric 600 such that the powder layer 505 is in contact with the fabric 600. Then, the adhesive powder constituting the powder layer 505 is melted. When the melted adhesive powder is cooled and solidified, the transfer sheet 520 and the fabric 600 adhere to each other. The fabric 600 is, for example, a fabric of a T-shirt.

Here, when the transfer sheet 520 adhered to the fabric 600 is peeled off from the fabric 600, the film layer 501, which is a layer outside the peeling layer 502 in the transfer sheet 520, is peeled off from the fabric 600. On the other hand, the receiving layer 503, the ink layer 504, and the powder layer 505, which are layers on the inner side of the peeling layer 502 in the transfer sheet 520, remain on the surface of the fabric 600. The printed fabric 610 in FIG. 2 is a fabric in which these layers are layered on the surface of the fabric 600 and an image is applied thereto.

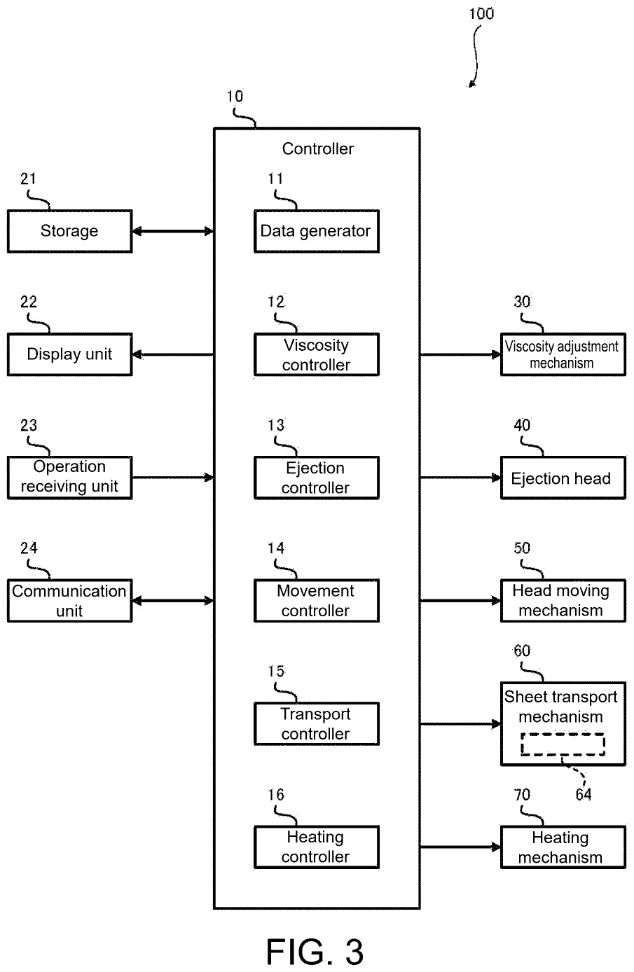

Next, a configuration of the print device 100 will be described with reference to FIG. 3. As shown in FIG. 3, the print device 100 includes a controller 10, a storage 21, a display unit 22, an operation receiving unit 23, a communication unit 24, a viscosity adjustment mechanism 30, an ejection head 40, a head moving mechanism 50, a sheet transport mechanism 60, and a heating mechanism 70.

The controller 10 controls the operation of the entire print device 100. The controller 10 includes a central processing unit (CPU), a read only memory (ROM), a random access memory (RAM), a real time clock (RTC), and the like. The CPU is also referred to as a central processor, an arithmetic processor, a processor, a microprocessor, a microcomputer, a digital signal processor (DSP), or the like, and functions as a central processor that executes processes and calculation related to control of the print device 100. In the controller 10, the CPU reads a program and data stored in the ROM, and integrally controls the print device 100 using the RAM as a work area. The RTC is, for example, an integrated circuit having a clocking function. The CPU can specify the current date and time from the time information read from the RTC. The controller 10 is an example of a printing unit that prints an image on the transfer sheet 500 with the transfer ink.

The storage 21 includes a nonvolatile semiconductor memory such as a flash memory, an erasable programmable ROM (EPROM), or an electrically erasable programmable ROM (EEPROM), and serves as a so-called secondary storage device or an auxiliary storage device. The storage 21 stores programs and data used by the controller 10 to execute various processes. In addition, the storage 21 stores data generated or acquired by the controller 10 executing various processes. For example, the storage 21 stores image data received by the print device 100 from the control device 400.

The display unit 22 displays various images under the control of the controller 10. The display unit 22 includes a touch screen, a liquid crystal display, and the like. The operation receiving unit 23 receives various operations from the user and supplies information indicating contents of the received operations to the controller 10. The operation receiving unit 23 includes a touch screen, a button, a lever, and the like.

The communication unit 24 communicates with various devices under the control of the controller 10. The communication unit 24 communicates with various devices in accordance with various wireless communication standards or various wired communication standards. Examples of various wireless communication standards include Wi-Fi (registered trademark), LTE (Long Term Evolution), 4G (4 th Generation), 5G (5 th Generation), Bluetooth (registered trademark), and Zigbee (registered trademark). Various wired communication standards include universal serial bus (Universal Serial Bus, registered trademark), Thunderbolt (registered trademark), and the like. The communication unit 24 includes a communication interface conforming to various communication standards.

The viscosity adjustment mechanism 30 is a mechanism for adjusting the viscosity of the ejected ink according to the control by the controller 10. Examples of the ejected ink include color ink for transfer and white ink for transfer. The viscosity of the ink varies depending on the temperature of the ink. Specifically, the viscosity of the ink is lower as the temperature of the ink is higher, and the viscosity of the ink is higher as the temperature of the ink is lower. The viscosity adjustment mechanism 30 adjusts the viscosity of the ejected ink by adjusting the temperature of the ejected ink. The viscosity adjustment mechanism 30 includes an ink flow path (not illustrated) through which ink flows, a heater (not illustrated) that heats the ink flow path under the control of the controller 10, a cooler (not illustrated) that cools the ink flow path under the control of the controller 10, and a temperature sensor (not illustrated) that measures the temperature of the ink or the ink flow path.

The ejection head 40 ejects the ink according to the control by the controller 10. The print device 100 includes an ejection head 40 for each type of the ink. That is, the print device 100 includes the ejection head 40 that ejects the color ink for transfer and the ejection head 40 that ejects the white ink for transfer. The ejection head 40 ejects the ink by an inkjet method such as a piezoelectric method or a thermal head method. The ejection head 40 is an example of an inkjet head.

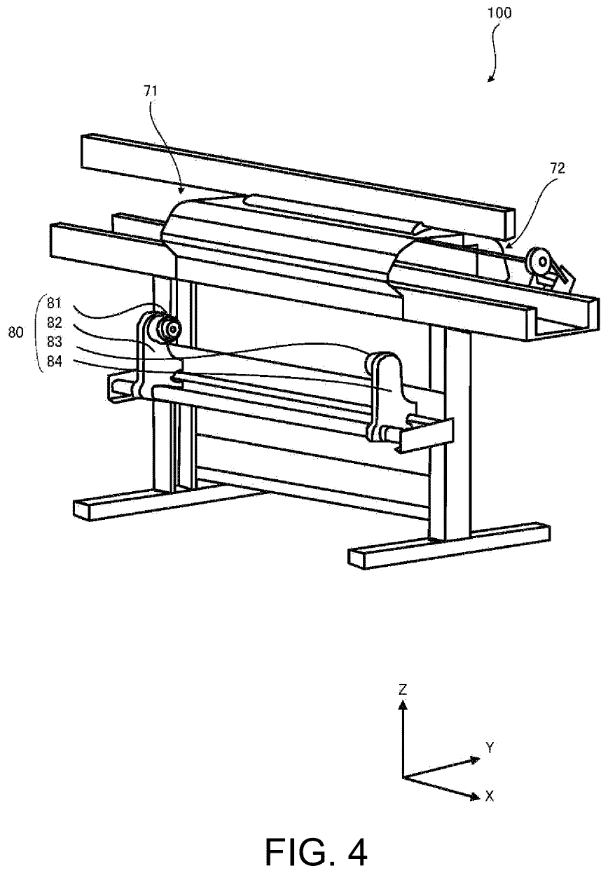

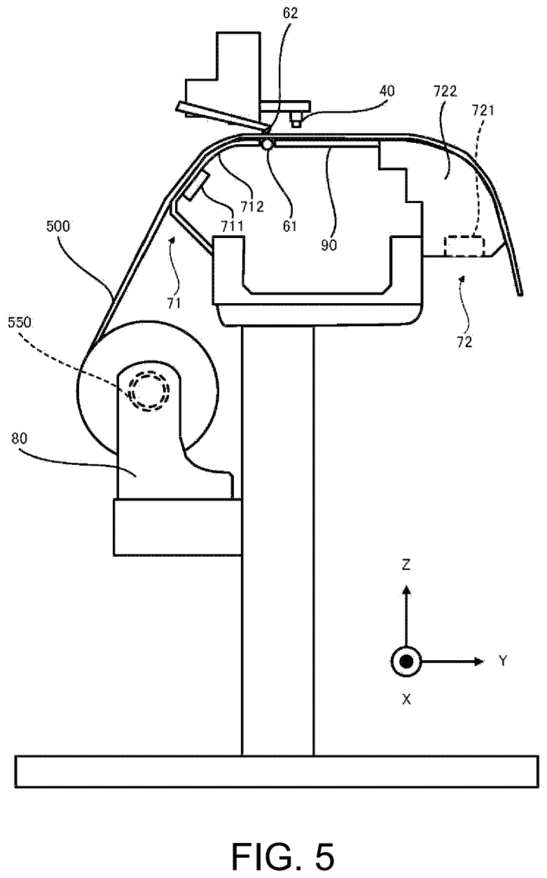

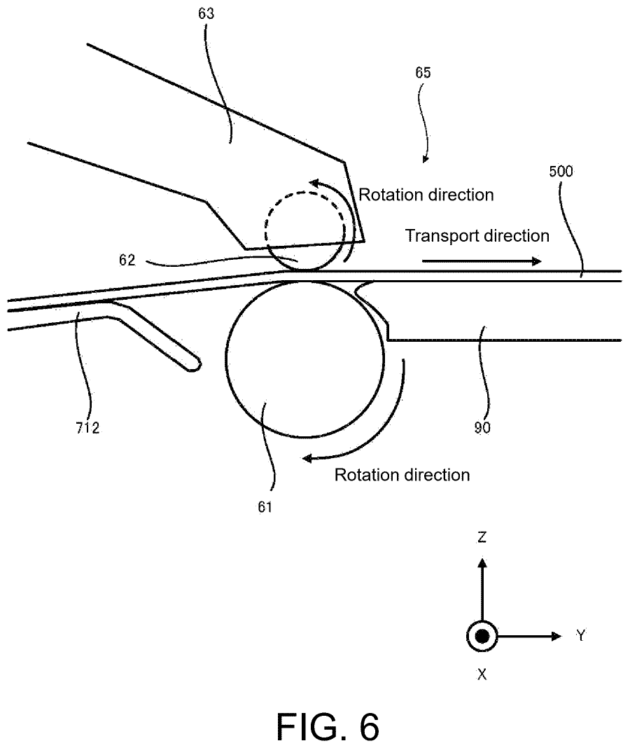

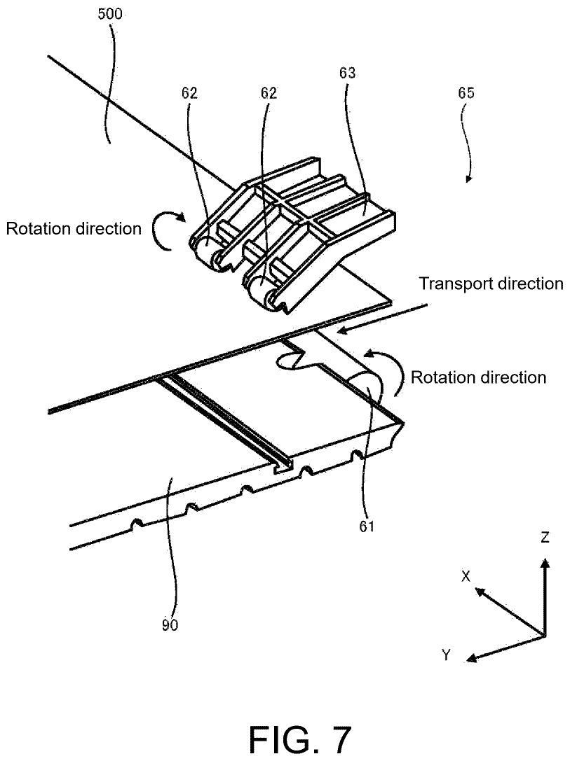

The head moving mechanism 50 is a mechanism configured to move the ejection head 40 under the control of the controller 10. The head moving mechanism 50 moves the ejection head 40 in the main scanning direction. The main scanning direction is the X-axis direction in FIGS. 4, 5, 6, and 7. FIG. 4 is an external view of the print device 100, and is a perspective view of the print device 100. FIG. 5 is a side view of the print device 100, and is a view of the print device 100 as viewed from the positive direction of the X-axis. FIG. 6 is a side view of a sheet clamping unit 65 of the print device 100. FIG. 7 is a perspective view of the sheet clamping unit 65 of the print device 100.

In FIGS. 4, 5, 6, and 7, the Z-axis is an axis extending in the vertical direction, the X-axis is an axis orthogonal to the Z-axis, and the Y-axis is an axis orthogonal to the X-axis and the Z-axis. A direction in which the arrow of the X-axis extends is a positive direction of the X-axis, and a direction opposite to the direction in which the arrow of the X-axis extends is a negative direction of the X-axis. A direction in which the arrow of the Y-axis extends is a positive direction of the Y-axis, and a direction opposite to the direction in which the arrow of the Y-axis extends is a negative direction of the Y-axis. A direction in which the arrow of the Z-axis extends is a positive direction of the Z-axis, and a direction opposite to the direction in which the arrow of the Z-axis extends is a negative direction of the Z-axis.

The head moving mechanism 50 includes, for example, a carriage (not illustrated), a guide rail (not illustrated), a drive belt (not illustrated), a drive pulley (not illustrated), a driven pulley (not illustrated), and a drive motor (not illustrated). The ejection head 40 as a moving object is mounted on the carriage. The guide rail guides movement of the carriage in a specified direction. The drive belt is fixed to the carriage. The drive belt is wound around the drive pulley and the driven pulley. The drive motor rotates the drive belt via the drive pulley to move the carriage in the X-axis direction.

The sheet transport mechanism 60 is a mechanism configured to transport the transfer sheet 500 under the control of the controller 10. The sheet transport mechanism 60 stretches the transfer sheet 500 wound in a roll shape and transports the transfer sheet 500 in the transport direction. The transport direction is basically a positive direction of the Y-axis. The sheet transport mechanism 60 includes a transport roller 61, a pinch roller 62, a roller support part 63, and a motor 64. The sheet clamping unit 65 in FIGS. 6 and 7 is the part that clamps the transfer sheet 500 in the sheet transport mechanism 60, and includes the transport roller 61 and the pinch roller 62.

The transport roller 61 is a roller that rotates in contact with the film layer 501 in the transfer sheet 500. The transport roller 61 includes a rotation shaft extending in the X-axis direction. The transport roller 61 rotates about a rotation shaft according to a driving force of the motor 64. The transport roller 61 rotates so that the transfer sheet 500 placed on the transport roller 61 is transported in the positive direction of the X-axis. Protrusions are provided in a lattice shape on the surface of the transport roller 61. The transport roller 61 is made of various resins, rubber, or the like.

The pinch roller 62 is a roller that rotates in contact with the receiving layer 503 of the transfer sheet 500. The pinch roller 62 includes a rotation shaft extending in the X-axis direction. The pinch roller 62 clamps the transfer sheet 500 together with the transport roller 61. That is, the transport roller 61 and the pinch roller 62 clamp the transfer sheet 500 as a medium from both sides with a strong force, and the transport roller 61 rotates, whereby the transfer sheet 500 is transported in the transport direction.

In the present embodiment, the portion of the pinch roller 62 that contacts the receiving layer 503 is less likely to adhere to the receiving layer 503 than the peeling layer 502 is. Therefore, when the transfer sheet 500 is clamped between the transport roller 61 and the pinch roller 62, the bonding force between the receiving layer 503 and the surface of the pinch roller 62 is weaker than the bonding force between the receiving layer 503 and the peeling layer 502. Therefore, in the present embodiment, it is suppressed that the receiving layer 503 is peeled off from the peeling layer 502 and adheres to the surface of the pinch roller 62 at the time of transporting the transfer sheet 500. The pinch roller 62 is formed of a low-adhesion material in which a portion that contacts the receiving layer 503 is less likely to adhere to the receiving layer 503 than the peeling layer 502 is.

The roller support part 63 is a member that rotatably supports the pinch roller 62. The motor 64 rotates the transport roller 61 under the control of the controller 10. The motor 64 converts, for example, electric energy supplied from a power source (not illustrated) into mechanical energy for rotating the transport roller 61.

The heating mechanism 70 is a mechanism configured to heat the transfer sheet 500 under the control of the controller 10. The heating mechanism 70 includes a rear-heater 71 and an after-heater 72. The rear-heater 71 is a heater that heats the transfer sheet 500 which is a transfer sheet before an image is printed. The after-heater 72 is a heater that heats the transfer sheet 510 which is a transfer sheet after an image is printed. The rear-heater 71 is disposed on the upstream side of the after-heater 72 on the transport path of the transfer sheet 500.

The rear-heater 71 includes, for example, a heater 711, a heated member 712, and a temperature sensor (not illustrated). The heater 711 is a heater that heats the heated member 712 under the control of the controller 10. The heated member 712 is a member heated by the heater 711. The transfer sheet 500 is transported over the heated member 712 and heated by the heated member 712. The temperature sensor is a sensor that measures the temperature of the heated member 712.

The after-heater 72 includes, for example, a heater 721, a heated member 722, and a temperature sensor (not illustrated). The heater 721 is a heater that heats the heated member 722 under the control of the controller 10. The heated member 722 is a member heated by the heater 721. The transfer sheet 510 is transported over the heated member 722 and heated by the heated member 722. The temperature sensor is a sensor that measures the temperature of the heated member 722.

Next, main functions of the controller 10 will be described in detail. The controller 10 functionally includes a data generator 11, a viscosity controller 12, an ejection controller 13, a movement controller 14, a transport controller 15, and a heating controller 16. Each of these functions is implemented by software, firmware, or a combination of software and firmware. The software and the firmware are described as programs and stored in the ROM or the storage 21. Then, the CPU executes the program stored in the ROM or the storage 21 to implement each of these functions.

The data generator 11 generates print control data necessary for printing an image. For example, the data generator 11 generates print control data indicating the type of the ink to be ejected, the ejection amount of the ink, the movement amount of the ejection head 40, and the like on the basis of the image data stored in the storage 21. The data generator 11 stores the generated print control data in the storage 21.

The ejection controller 13 controls ejection of the ink by the ejection head 40. The ejection controller 13 controls the ejection head 40 to cause the ejection head 40 to eject the ink. The ejection controller 13 causes the ejection head 40 to eject the ink on the basis of the print control data generated by the data generator 11.

The movement controller 14 controls the movement of the ejection head 40. Specifically, the movement controller 14 controls the head moving mechanism 50 to move the ejection head 40 in the main scanning direction. For example, the movement controller 14 changes the position of the ejection head 40 in the main scanning direction every time the ejection head 40 completes the ejection of the ink.

The transport controller 15 controls transport of the transfer sheet 500. Specifically, the transport controller 15 controls the sheet transport mechanism 60 to transport the transfer sheet 500 in the transport direction. For example, every time printing of an image at a specific position in the transport direction of the transfer sheet 500 is completed, the transport controller 15 rotates the motor 64 by a specified angle and transports the transfer sheet 500 in the transport direction by a specified distance.

The heating controller 16 controls heating of the transfer sheet 500 and the transfer sheet 510. Specifically, the heating controller 16 controls the heating mechanism 70 to heat the transfer sheet 500 and the transfer sheet 510. For example, the heating controller 16 controls the rear-heater 71 to heat the transfer sheet 500. The heating controller 16 controls the after-heater 72 to heat the transfer sheet 510.

Next, a method in which the print device 100 prints an image on the transfer sheet 500 while transporting the transfer sheet 500 will be described with reference to FIGS. 4 and 5.

First, before performing printing, an operator sets the transfer sheet 500 wound in a roll shape around a paper core 550 in a roll holder 80 included in the print device 100 as illustrated in FIGS. 4 and 5. The roll holder 80 includes a protrusion 81 into which one end of the paper core 550 is fitted, a support 82 that supports the protrusion 81, a protrusion 83 into which the other end of the paper core 550 is fitted, and a support part 84 that supports the protrusion 83. The operator fits one end of the paper core 550 into the protrusion 81 and fits the other end of the paper core 550 into the protrusion 83. As a result, the roll holder 80 clamps the paper core 550 from both ends of the paper core 550 and holds the transfer sheet 500.

Next, the operator stretches the roll-shaped transfer sheet 500 held by the roll holder 80 along the transport path. Specifically, the operator stretches the transfer sheet 500 by passing it over the heated member 712 of the rear-heater 71, over the platen 90, and over the heated member 722 of the after-heater 72. Then, the operator operates the control device 400 to start printing by the print device 100. The print device 100 prints an image on a region of the transfer sheet 500 disposed on the platen 90.

The print device 100 starts heating by the rear-heater 71 and the after-heater 72 prior to printing. The print device 100 rotates the transport roller 61 to transport the transfer sheet 500 heated by the rear-heater 71 in the transport direction. The print device 100 prints an image with the color ink for transfer on a region of the heated transfer sheet 500 disposed on the platen 90.

Further, the print device 100 applies the white ink to a region of the transfer sheet 500 on which an image is printed with the color ink. The print device 100 rotates the transport roller 61 to transport the transfer sheet 510 coated with the white ink onto the heated member 722 included in the after-heater 72. The print device 100 supplies the transfer sheet 510 heated by the after-heater 72 to the powder applicator 200.

Next, a method in which the print device 100 transports the transfer sheet 500 will be described in detail with reference to FIGS. 6 and 7.

As illustrated in FIGS. 6 and 7, the print device 100 transports the transport roller 61 in the transport direction by rotating the transport roller 61 in a state where the transfer sheet 500 is clamped between the transport roller 61 and the pinch roller 62. At this time, the surface of the transport roller 61 is pressed against the surface of the film layer 501 of the transfer sheet 500, and the surface of the pinch roller 62 is pressed against the surface of the receiving layer 503 of the transfer sheet 500.

Here, in order to stretch and transport the roll-shaped transfer sheet 500 mounted on the roll holder 80, it is necessary to clamp the transfer sheet 500 with a strong force. That is, when the force for clamping the transfer sheet 500 is weak, slippage occurs between the surface of the transport roller 61 and the surface of the film layer 501 of the transfer sheet 500. In this case, the transport roller 61 idles, and the transfer sheet 500 cannot be appropriately transported. Therefore, in the print device 100, the transfer sheet 500 is clamped between the transport roller 61 and the pinch roller 62 with a strong force at the time of transporting the transfer sheet 500.

Meanwhile, since the receiving layer 503 of the transfer sheet 500 needs to receive the transfer ink, it is designed so that the adhesive force becomes strong. For example, a material having strong adhesive force is adopted as the material of the receiving layer 503, and a porous structure having strong adhesive force is adopted as the structure of the receiving layer 503. Therefore, when the transfer sheet 500 is clamped between the transport roller 61 and the pinch roller 62 with a strong force, the receiving layer 503 may be peeled off from the transfer sheet 500, and the peeled receiving layer 503 may adhere to the surface of the pinch roller 62.

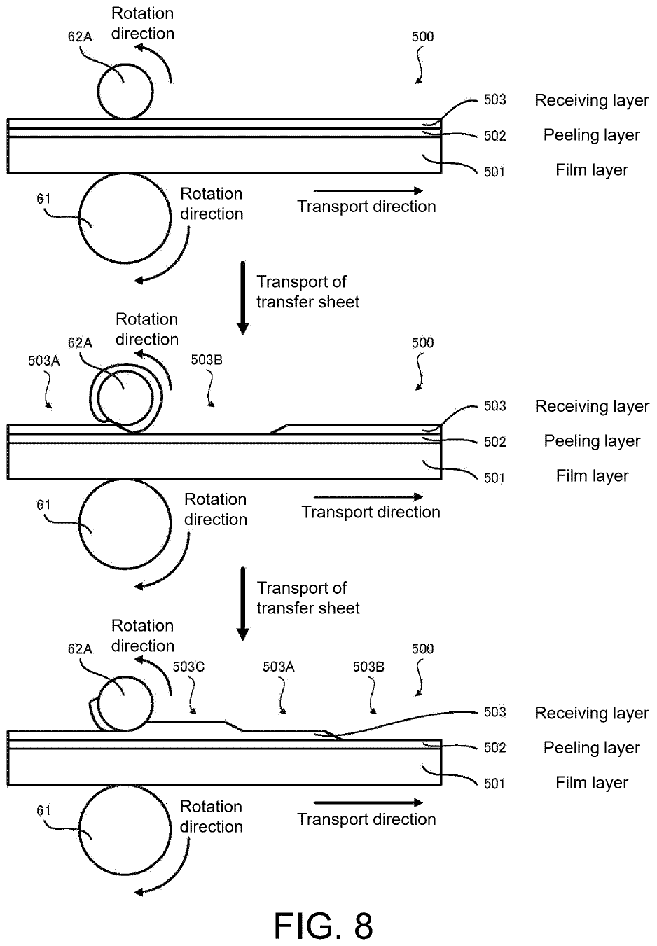

Hereinafter, a state in which the receiving layer 503 is peeled off from the transfer sheet 500 when a pinch roller 62A according to the comparative example is adopted will be described with reference to FIG. 8. Note that the surface of the pinch roller 62A is formed of general rubber, and the adhesive force of the surface of the pinch roller 62A is high. In this case, a portion of the pinch roller 62A that contacts the receiving layer 503 may be more likely to adhere to the receiving layer than the peeling layer 502 is.

The upper part of FIG. 8 illustrates a state in which the transfer sheet 500, which is a medium, is clamped between the transport roller 61 and the pinch roller 62 with a strong force from both sides, and the transport roller 61 is rotated to transport the transfer sheet 500 in the transport direction. The middle part of FIG. 8 illustrates a state in which a part of the receiving layer 503 is peeled off from the peeling layer 502 and adhered to the surface of the pinch roller 62A. A region 503A is a region where the receiving layer 503 is not peeled off from the peeling layer 502, and a region 503B is a region where the receiving layer 503 is peeled off from the peeling layer 502.

The lower part of FIG. 8 illustrates a state in which a part of the receiving layer 503 adhered to the surface of the pinch roller 62A is peeled off from the surface of the pinch roller 62A and adhered to the surface of the receiving layer 503. A region 503C is a region where a part of the receiving layer 503 adhered to the surface of the pinch roller 62A is adhered to the surface of the receiving layer 503.

As illustrated in FIG. 8, when the pinch roller 62A according to the comparative example is adopted, unevenness due to a difference in thickness of the receiving layer 503 may occur on the surface of the transfer sheet 500. For example, the region 503B where the receiving layer 503 is peeled off is recessed more than the surrounding region, and the region 503C where the receiving layer 503 is adhered protrudes more than the surrounding region.

Note that, although FIG. 8 shows an example in which the entire layer of the receiving layer 503 is peeled off from the transfer sheet 500, there is a possibility that a part of the layer of the receiving layer 503 is peeled off from the transfer sheet 500. For example, only the layer above the receiving layer 503 may be peeled off from the transfer sheet 500, and the layer below the receiving layer 503 may remain on the transfer sheet 500.

If unevenness are generated on the surface of the transfer sheet 500, there is a high possibility that appropriate printing, appropriate powder application, appropriate thermal transfer, and the like cannot be realized. That is, when unevenness are generated on the surface of the transfer sheet 500, there is a high possibility that appropriate transfer printing cannot be realized. Accordingly, the pinch roller 62, having lower adhesion to the receiving layer 503 than the pinch roller 62A of the comparative example, is used in the present embodiment.

The pinch roller 62 is configured to hardly adhere to the receiving layer 503. Typically, the pinch roller 62 is formed of a low-adhesion material in which a portion that contacts the receiving layer 503 is less likely to adhere to the receiving layer 503 than the peeling layer 502 is. Examples of the low-adhesion material include a fluorine-containing compound, a silicon-containing compound, and an oil-containing polyoxymethylene (POM). That is, the portion of the pinch roller 62 that contacts the receiving layer 503 is formed of at least one low-adhesion material selected from a fluorine-containing compound, a silicon-containing compound, and an oil-containing POM. Note that the portion of the pinch roller 62 that does not contact the receiving layer 503 may be formed of a low-adhesion material or may be formed of a material that is not low-adhesion. Examples of the material that is not low-adhesion include rubber and sponge.

As described above, by making the surface of the pinch roller 62 less likely to adhere to the receiving layer 503 than the peeling layer 502 is, peeling of the receiving layer 503 from the peeling layer 502 is suppressed. If the adhesive force between the surface of the pinch roller 62 and the receiving layer 503 is weaker than the adhesive force between the peeling layer 502 and the receiving layer 503, it is considered that there is a low possibility that only the upper layer of the receiving layer 503 is peeled off from the transfer sheet 500 and adheres to the surface of the pinch roller 62.

In the present embodiment, the portion of the pinch roller 62 that contacts the receiving layer 503 is less likely to adhere to the receiving layer 503 than the peeling layer 502 is. Therefore, in the present embodiment, peeling of the receiving layer 503 from the peeling layer 502 during transport of the transfer sheet 500 is suppressed. Therefore, according to the present embodiment, appropriate transfer printing can be expected.

In the present embodiment, the pinch roller 62 is formed of a low-adhesion material in which a portion that contacts the receiving layer 503 is less likely to adhere to the receiving layer 503 than the peeling layer 502 is. Therefore, in the present embodiment, peeling of the receiving layer 503 from the peeling layer 502 during transport of the transfer sheet 500 is appropriately suppressed.

### Modified Example

Although the embodiment have been described above, modifications and applications according to various forms are possible. The adoption of any of the configurations, functions, and operations described in the foregoing embodiment is optional. Further, in addition to the configurations, functions, and operations described above, additional configurations, functions, and operations may also be adopted. Furthermore, any combination of the configurations, functions, and operations described in the foregoing embodiment may be adopted as desired.

In the embodiment, an example in which the transfer sheet 500 wound in a roll shape is stretched and transported at the time of printing has been described. The transfer sheet 500 may not be wound in a roll shape. Even in this case, an effect of suppressing peeling of the receiving layer 503 from the peeling layer 502 can be expected.

In the embodiment, in order to suppress the influence of the color of the fabric of the transfer target medium, an example in which the white ink for transfer is layered on the color ink for transfer has been described. The white ink for transfer may not be layered on the color ink for transfer.

In the embodiment, in the controller 10, the CPU functions as each unit illustrated in FIG. 3 by executing a program stored in the ROM or the storage 21. However, in the present disclosure, the controller 10 may be dedicated hardware. The dedicated hardware is, for example, a single circuit, a composite circuit, a programmed processor, an application specific integrated circuit (ASIC), a field-programmable gate array (FPGA), or a combination thereof. In a case where the controller 10 is dedicated hardware, the functions of the respective units may be realized by individual hardware, or the functions of the respective units may be collectively realized by a single hardware. In addition, some of the functions of the respective units may be implemented by dedicated hardware, and other functions may be implemented by software or firmware. As described above, the controller 10 can implement the above-described functions by hardware, software, firmware, or a combination thereof.

By applying an operation program that defines the operation of the print device 100 according to the present disclosure to an existing computer such as a personal computer or an information terminal device, the computer can be caused to function as the print device 100 according to the present disclosure. Furthermore, a distribution method of such a program is optional, and for example, the program may be stored and distributed in a computer-readable recording medium such as a compact disk ROM (CD-ROM), a digital versatile disk (DVD), a magneto optical disk (MO), or a memory card, or may be distributed via a communication network such as the Internet.

The present disclosure enables various embodiments and modifications without departing from the broad spirit and scope of the present disclosure. In addition, the above-described embodiment is for describing the present disclosure, and do not limit the scope of the present disclosure. That is, the scope of the present disclosure is indicated by the claims rather than the embodiment. Various modifications made within the scope of the claims and within the meaning of the equivalent disclosure are deemed to be within the scope of the present disclosure.

### Another Embodiment 1

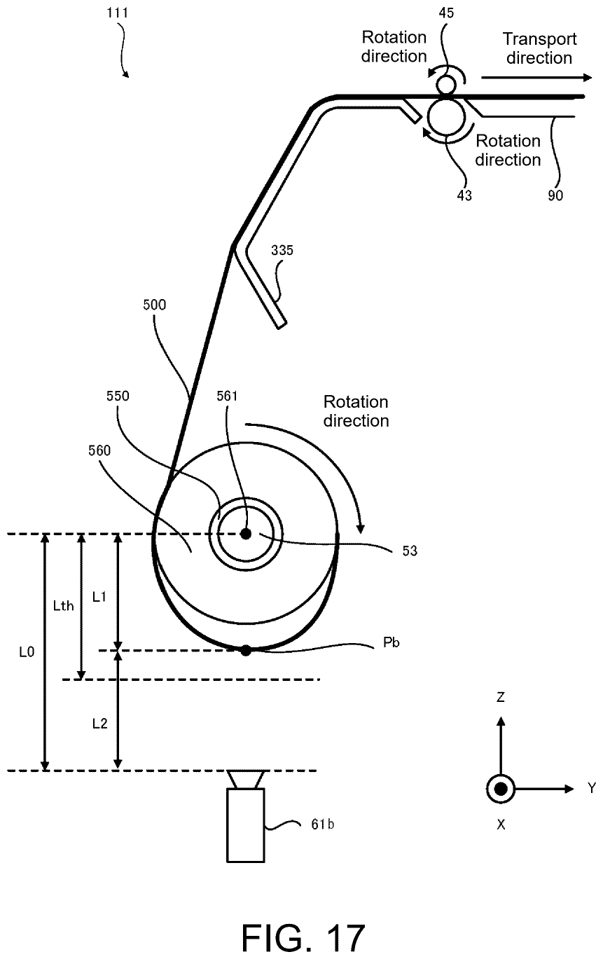

First, a configuration of a print system 1000 according to Another embodiment 1 will be described with reference to FIG. 17. The print system 1000 is a system that forms an image on a transfer target medium, which is a medium to be printed, by transfer printing using a transfer sheet. The transfer printing is a printing method in which an image is not directly printed on a transfer target medium, but an image is applied to the transfer target medium by transfer using a transfer sheet. In transfer printing, an image is printed in advance on a transfer sheet with the transfer ink, and heat and pressure are applied to the transfer sheet layered on a transfer target medium to attach the image to the transfer target medium.

The transfer sheet is a sheet-like medium on which an image to be attached to a transfer target medium is printed with the transfer ink. In the present embodiment, before an image is printed, the transfer sheet is wound in a roll shape, and an image is printed on the transfer sheet that has been pulled out at the time of printing the image. The transfer target medium is a medium to be printed, and is a medium on which an image is finally formed by transfer printing. The transfer target medium is a medium that is difficult to directly print by normal printing. The transfer target medium is, for example, clothing including nylon clothing, a towel, an enamel bag, an umbrella, or the like. In the present embodiment, the transfer target medium is a T-shirt. As illustrated in FIG. 17, the print system 1000 includes a print device 100b, a powder applicator 27 200b, a transfer device 300b, and a control device 400.

The print device 100b prints an image with the transfer ink on the transfer sheet under the control of the control device 400. For example, the print device 100b acquires image data from the control device 400, and specifies an image printing region that is a region on which an image is printed on the transfer sheet on the basis of the image data. The print device 100b ejects the color ink for transfer corresponding to an image indicated by image data onto an image printing region on the transfer sheet. Thereafter, the print device 100b ejects the white ink for transfer onto the image printing region on the transfer sheet.

The reason for layering the white ink for transfer on the color ink for transfer is to suppress the influence of the color of the fabric of the transfer target medium. Hereinafter, the color ink for transfer and the white ink for transfer will be collectively referred to as transfer ink as appropriate. As the transfer ink, a pigment ink, a UV (Ultraviolet) ink, a solvent ink, and the like can be employed. In the present embodiment, the transfer ink is a pigment ink. The print device 100b includes a transport device 110 that transports the transfer sheet.

The powder applicator 200b applies the powder to the transfer sheet on which the image is printed by the print device 100b. Specifically, the powder applicator 200b applies the powder to the region on the transfer sheet to which the white ink has been applied, before the applied white ink on the transfer sheet dries. This powder is an adhesive powder that exhibits adhesiveness when melted. For example, the powder applicator 200b may coat the entire surface of the transfer sheet with the powder, and cause the powder to adhere only to the region on the transfer sheet to which the white ink has been applied.

The transfer device 300b transfers the image drawn on the transfer sheet to which the powder has been applied by the powder applicator 200b to the transfer target medium. The transfer device 300b transfers the image drawn on the transfer sheet to the transfer target medium by thermal transfer. That is, the transfer device 300b applies heat and pressure to the transfer sheet layered on the transfer medium so that the surface to which the powder is applied covers the transfer target medium. Then, the powder melts and the transfer sheet and the transfer target medium adhere to each other. When the transfer sheet is peeled off from the transfer target medium after the transfer sheet and the transfer target medium are cooled, an image drawn with the transfer ink remains on the transfer target medium.

The control device 400 is a device that controls the print device 100b. For example, the control device 400 transmits image data indicating an image to be drawn on the transfer sheet to the print device 100b, and instructs the print device 100b to print the image. The control device 400 may transmit information specifying the number of images to be printed, the size of the image to be printed, and the like to the print device 100b. The control device 400 includes a communication interface (not illustrated) for communicating with the print device 100b. The control device 400 is a personal computer, a tablet terminal, a smartphone, or the like.

In the print system 1000, the application of the transfer ink by the print device 100b and the application of the powder by the powder applicator 200b are sequentially executed while the roll-shaped transfer sheet is stretched and rewound in the roll shape. In the print system 1000, the transfer sheet to which the powder has been applied by the powder applicator 200b is cut into a desired size, and the transfer device 300b performs thermal transfer on the cut transfer sheet and the transfer target medium.

The print device 100b and the powder applicator 200b may be installed in the same facility, and the print device 100b and the transfer device 300b may be installed in different facilities. For example, the print device 100b and the powder applicator 200b may be installed in a factory that manufactures a transfer sheet to which powder is applied, and the transfer device 300b may be installed in a factory that manufactures a transfer target medium to which an image is applied by transfer printing. The print device 100b and the powder applicator 200b may not be synchronized with each other and may not communicate with each other.

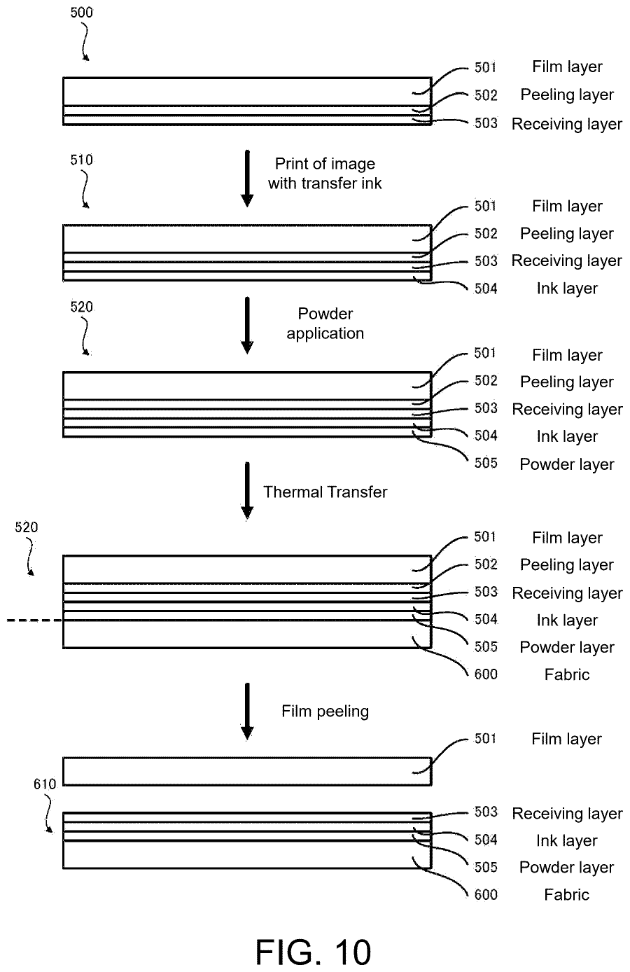

Next, transfer printing executed by the print system 1000 will be described with reference to FIG. 10.

First, the print device 100b prints an image on the transfer sheet 500 with the transfer ink. The transfer sheet 500 is a transfer sheet before being processed by the print device 100b. The transfer sheet 500 includes a film layer 501, a peeling layer 502, and a receiving layer 503.

The film layer 501 is a layer that supports the receiving layer 503 via the peeling layer 502. The film layer 501 is a layer serving as a base of the receiving layer 503. The film layer 501 is, for example, a layer made of various resins.

The peeling layer 502 is a layer that joins the film layer 501 and the receiving layer 503 in a peelable manner. The peeling layer 502 is a layer for separating the film layer 501 and the receiving layer 503 when the transfer sheet 500 adhered to the transfer target medium is peeled off from the transfer target medium. The peeling layer 502 is, for example, a layer including a fluorine-based peeling agent or a silicon-based peeling agent.

The receiving layer 503 is a layer that receives the transfer ink. It is preferable that the receiving layer 503 be configured with a material and a structure exhibiting excellent adsorption properties for the transfer ink. For example, it is preferable that the receiving layer 503 be configured with a porous material. In addition, it is preferable that the receiving layer 503 be configured to include at least one of polyvinyl alcohol (PVA) and polyvinyl chloride (PVC), for example.

The print device 100b prints an image on the receiving layer 503 of the transfer sheet 500 with the color ink for transfer. Thereafter, the print device 100b applies the white ink for transfer to the region where the image is printed with the color ink for transfer on the transfer sheet 500. The print device 100b generates the transfer sheet 510 by printing an image on the transfer sheet 500 with the transfer ink.

The transfer sheet 510 includes the film layer 501, the peeling layer 502, the receiving layer 503, and an ink layer 504. The ink layer 504 is a layer containing the transfer ink. The ink layer 504 is a layer formed on the surface or inside of the receiving layer 503 by sequentially layering the color ink for transfer and the white ink for transfer with respect to the receiving layer 503.

In FIG. 10, a layer of color ink for transfer and a layer of white ink for transfer are not distinguished from each other, and are collectively shown as a single layer of transfer ink. In FIG. 10, the receiving layer 503 and the ink layer 504 are layered, but the receiving layer 503 and the ink layer 504 may be integrated.

The powder applicator 200b applies an adhesive powder to the ink layer 504 of the transfer sheet 510. The powder applicator 200b applies an adhesive powder to the transfer sheet 510 to generate the transfer sheet 520. The transfer sheet 520 includes the film layer 501, the peeling layer 502, the receiving layer 503, the ink layer 504, and a powder layer 505. The powder layer 505 is a layer formed of an adhesive powder.

The transfer device 300b thermally transfers the image drawn on the transfer sheet 520 to a fabric 600. Specifically, the transfer device 300b applies heat and pressure to the transfer sheet 520 layered on the fabric 600 such that the powder layer 505 is in contact with the fabric 600. Then, the adhesive powder constituting the powder layer 505 is melted. When the melted adhesive powder is cooled and solidified, the transfer sheet 520 and the fabric 600 adhere to each other. The fabric 600 is, for example, a fabric of a T-shirt.

Here, when the transfer sheet 520 adhered to the fabric 600 is peeled off from the fabric 600, the film layer 501, which is a layer outside the peeling layer 502 in the transfer sheet 520, is peeled off from the fabric 600. On the other hand, the receiving layer 503, the ink layer 504, and the powder layer 505, which are layers on the inner side of the peeling layer 502 in the transfer sheet 520, remain on the surface of the fabric 600. The printed fabric 610 in FIG. 10 is a fabric in which these layers are layered on the surface of the fabric 600 and an image is applied thereto.

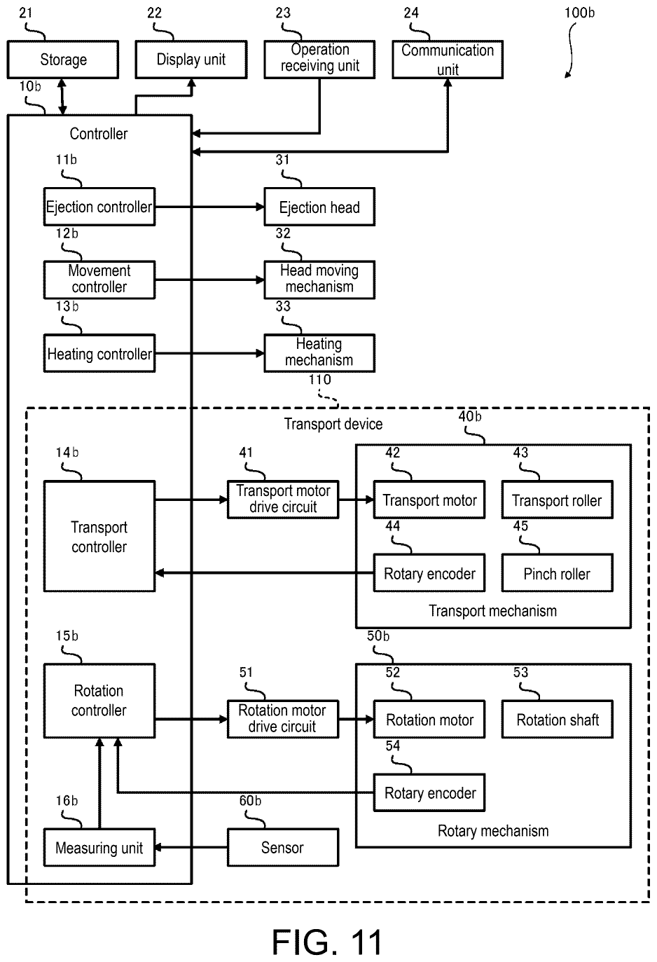

Next, a configuration of the print device 100b will be described with reference to FIG. 11. As shown in FIG. 11, the print device 100b includes a controller 10b, a storage 21, a display unit 22, an operation receiving unit 23, a communication unit 24, an ejection head 31, a head moving mechanism 32, a heating mechanism 33, a transport mechanism 40b, a transport motor drive circuit 41, a rotary mechanism 50b, and a rotation motor drive circuit 51. In the configuration of the print device 100b, a portion including the controller 10b, the transport mechanism 40b, the transport motor drive circuit 41, the rotary mechanism 50b, and the rotation motor drive circuit 51 constitutes the transport device 110.

The controller 10b controls the operation of the entire print device 100b. The controller 10b includes a central processing unit (CPU), a read only memory (ROM), a random access memory (RAM), a real time clock (RTC), and the like. The CPU is also referred to as a central processor, an arithmetic processor, a processor, a microprocessor, a microcomputer, a digital signal processor (DSP), or the like, and functions as a central processor that executes processes and calculation related to control of the print device 100b. In the controller 10b, the CPU reads a program and data stored in the ROM, and integrally controls the print device 100b using the RAM as a work area. The RTC is, for example, an integrated circuit having a clocking function. The CPU can specify the current date and time from the time information read from the RTC. The controller 10b is an example of a printing unit that prints an image on the transfer sheet 500 with the transfer ink.

The storage 21 includes a nonvolatile semiconductor memory such as a flash memory, an erasable programmable ROM (EPROM), or an electrically erasable programmable ROM (EEPROM), and serves as a so-called secondary storage device or an auxiliary storage device. The storage 21 stores programs and data used by the controller 10b to execute various processes. In addition, the storage 21 stores data generated or acquired by the controller 10b executing various processes.

The display unit 22 displays various images under the control of the controller 10b. The display unit 22 includes a touch screen, a liquid crystal display, and the like. The operation receiving unit 23 receives various operations from the user and supplies information indicating contents of the received operations to the controller 10b. The operation receiving unit 23 includes a touch screen, a button, a lever, and the like.

The communication unit 24 communicates with various devices under the control of the controller 10b. The communication unit 24 communicates with various devices in accordance with various wireless communication standards or various wired communication standards. Examples of various wireless communication standards include Wi-Fi (registered trademark), LTE (Long Term Evolution), 4G (4 th Generation), 5G (5 th Generation), Bluetooth (registered trademark), and Zigbee (registered trademark). Various wired communication standards include universal serial bus (Universal Serial Bus, registered trademark), Thunderbolt (registered trademark), and the like. The communication unit 24 includes a communication interface conforming to various communication standards.

The ejection head 31 ejects the ink according to the control by the controller 10b. The print device 100b includes the ejection head 31 for each type of the ink. That is, the print device 100b includes the ejection head 31 that ejects the color ink for transfer and the ejection head 31 that ejects the white ink for transfer. The ejection head 31 ejects the ink by an inkjet method such as a piezoelectric method or a thermal head method.

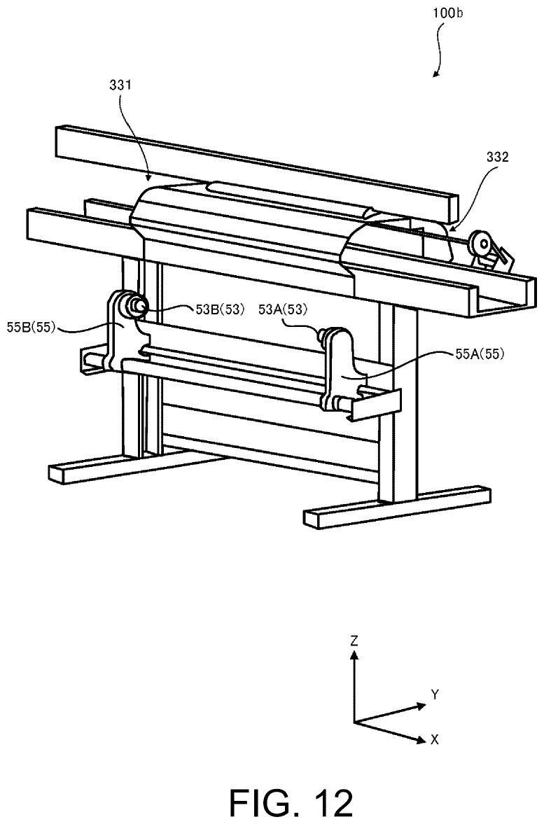

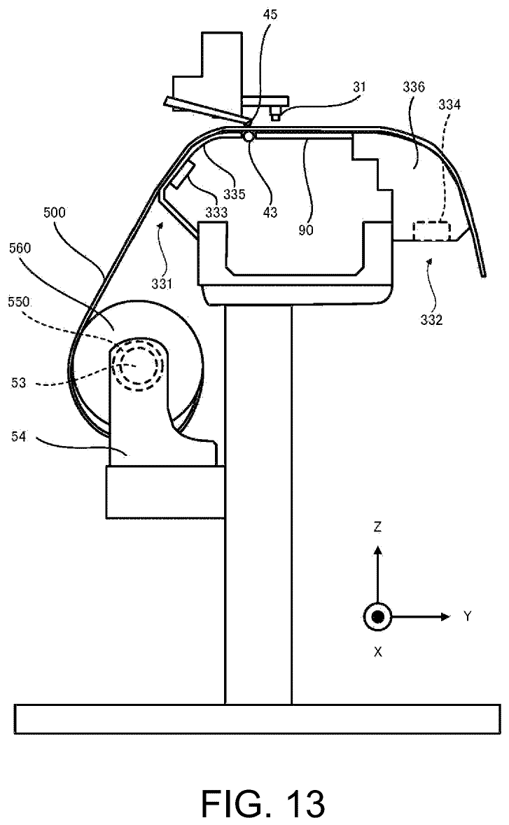

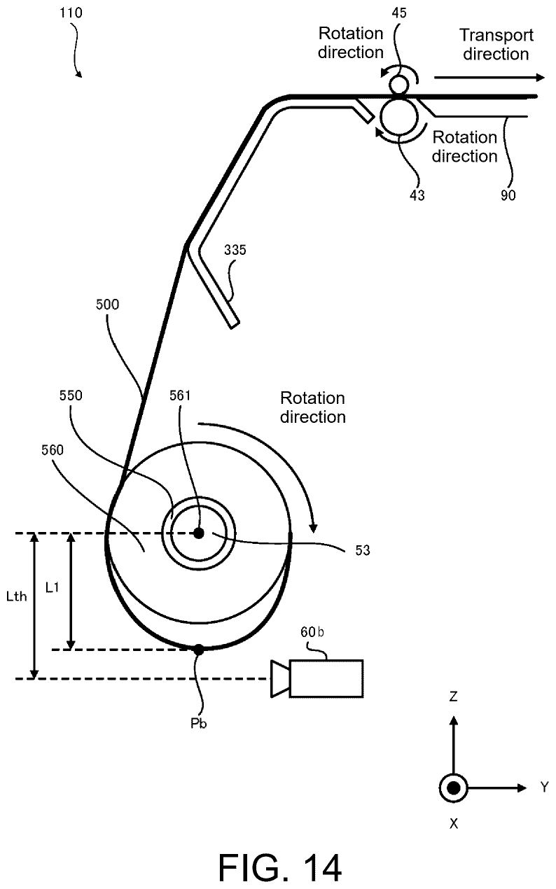

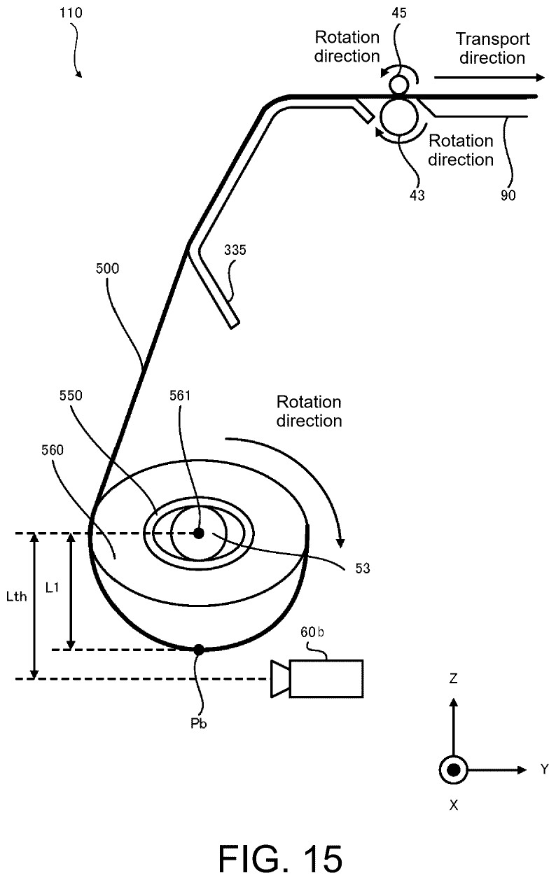

The head moving mechanism 32 is a mechanism configured to move the ejection head 31 under the control of the controller 10b. The head moving mechanism 32 moves the ejection head 31 in the main scanning direction. The main scanning direction is the X-axis direction in FIGS. 12, 13, 14, and 15. FIG. 12 is an external view of the print device 100b, and is a perspective view of the print device 100b. FIG. 13 is a side view of the print device 100b, and is a view of the print device 100b as viewed from the positive direction of the X-axis. FIG. 14 is a first explanatory diagram of the operation of the transport device 110. FIG. 15 is a second explanatory diagram of the operation of the transport device 110.

In FIGS. 12, 13, 14, and 15, the Z-axis is an axis extending in the vertical direction, the X-axis is an axis orthogonal to the Z-axis, and the Y-axis is an axis orthogonal to the X-axis and the Z-axis. A direction in which the arrow of the X-axis extends is a positive direction of the X-axis, and a direction opposite to the direction in which the arrow of the X-axis extends is a negative direction of the X-axis. A direction in which the arrow of the Y-axis extends is a positive direction of the Y-axis, and a direction opposite to the direction in which the arrow of the Y-axis extends is a negative direction of the Y-axis. A direction in which the arrow of the Z-axis extends is a positive direction of the Z-axis, and a direction opposite to the direction in which the arrow of the Z-axis extends is a negative direction of the Z-axis.

The head moving mechanism 32 includes, for example, a carriage (not illustrated), a guide rail (not illustrated), a drive belt (not illustrated), a drive pulley (not illustrated), a driven pulley (not illustrated), and a drive motor (not illustrated). The ejection head 31 as a moving object is mounted on the carriage. The guide rail guides movement of the carriage in a specified direction. The drive belt is fixed to the carriage. The drive belt is wound around the drive pulley and the driven pulley. The drive motor rotates the drive belt via the drive pulley to move the carriage in the X-axis direction.

The heating mechanism 33 is a mechanism configured to heat the transfer sheet 500 under the control of the controller 10b. The heating mechanism 33 includes a rear-heater 331 and an after-heater 332. The rear-heater 331 is a heater that heats the transfer sheet 500 which is a transfer sheet before an image is printed. The after-heater 332 is a heater that heats the transfer sheet 510 which is a transfer sheet after an image is printed. The rear-heater 331 is disposed on the upstream side of the after-heater 332 on the transport path of the transfer sheet 500.

The rear-heater 331 includes, for example, a heater 333, a heated member 335, and a temperature sensor (not illustrated). The heater 333 is a heater that heats the heated member 335 under the control of the controller 10b. The heated member 335 is a member heated by the heater 333. The transfer sheet 500 is transported over the heated member 335 and heated by the heated member 335. The temperature sensor is a sensor that measures the temperature of the heated member 335.

The after-heater 332 includes, for example, a heater 334, a heated member 336, and a temperature sensor (not illustrated). The heater 334 is a heater that heats the heated member 336 under the control of the controller 10b. The heated member 336 is a member heated by the heater 334. The transfer sheet 510 is transported over the heated member 336 and heated by the heated member 336. The temperature sensor is a sensor that measures the temperature of the heated member 336.

The transport mechanism 40b is a mechanism configured to transport the transfer sheet 500 unwound from a roll body 560 toward the downstream of the transport path under the control of the controller 10b. The roll body 560 is formed by winding the transfer sheet 500, which is a wide, long, and thin sheet-like medium, around the paper core 550. The transport path is a path through which the transfer sheet 500 is transported. The transport path is, for example, a path that passes over the surfaces of the roll body 560, the heated member 335, the transport roller 43, a platen 90b, the heated member 336, and the like. The transport mechanism 40b includes a transport motor 42, a transport roller 43, a rotary encoder 44, and a pinch roller 45.

The transport motor drive circuit 41 is a circuit for driving the transport motor 42 under the control of the controller 10b. Specifically, the transport motor drive circuit 41 generates a drive signal for driving the transport motor 42 under the control of a transport controller 14b included in the controller 10b, and drives the transport motor 42 by the generated drive signal.

The transport motor 42 rotates the transport roller 43 under the control of the controller 10b. Specifically, the transport motor 42 rotates a rotation shaft (not illustrated) of the transport motor 42 according to a drive signal output from the transport motor drive circuit 41 controlled by the transport controller 14b. By the rotation of the rotation shaft of the transport motor 42, the transport roller 43 rotates about a rotation shaft (not illustrated) of the transport roller 43. The transport motor 42 converts, for example, electric energy supplied from a power source (not illustrated) into mechanical energy for rotating the transport roller 43. The transport motor 42 is, for example, a stepping motor.

The transport roller 43 is a roller that rotates in contact with the film layer 501 of the transfer sheet 500. The transport roller 43 includes a rotation shaft extending in the X-axis direction. The transport roller 43 rotates about a rotation shaft according to a driving force by the of the transport motor 42. The transport roller 43 rotates so that the transfer sheet 500 placed on the transport roller 43 is transported in the positive direction of the Y-axis. Protrusions are provided in a lattice shape on the surface of the transport roller 43. The transport roller 43 is made of various resins, rubber, or the like.

The rotary encoder 44 is a sensor that converts a mechanical displacement amount of rotation into an electric signal and processes the electric signal to detect a position, a speed, and the like. For example, the rotary encoder 44 supplies a rotation angle signal indicating an angle at which the transport roller 43 has rotated to the transport controller 14b.

The pinch roller 45 is a roller that rotates in contact with the receiving layer 503 of the transfer sheet 500. The pinch roller 45 includes a rotation shaft extending in the X-axis direction (not illustrated). The pinch roller 45 clamps the transfer sheet 500 together with the transport roller 43. That is, the transport roller 43 and the pinch roller 45 clamp the transfer sheet 500 as a medium from both sides with a strong force, and the transport roller 43 rotates, whereby the transfer sheet 500 is transported. The pinch roller 45 is made of, for example, rubber.

The rotary mechanism 50b is a mechanism configured to support the roll body 560 such that a central axis 561 of the roll body 560 is horizontal and rotates the roll body 560. Specifically, the rotary mechanism 50b rotates the roll body 560 about the central axis 561 of the roll body 560 under the control of the controller 10b. The rotary mechanism 50b includes a rotation motor 52, a rotation shaft 53, and a rotary encoder 54.

The rotation motor drive circuit 51 is a circuit for driving the rotation motor 52 under the control of the controller 10b. Specifically, the rotation motor drive circuit 51 generates a drive signal for driving the rotation motor 52 under the control of a rotation controller 15b included in the controller 10b, and drives the rotation motor 52 by the generated drive signal.

The rotation motor 52 rotates the roll body 560 under the control of the controller 10b. Specifically, the rotation motor 52 rotates a rotation shaft (not illustrated) of the rotation motor 52 according to a drive signal output from the rotation motor drive circuit 51 controlled by the rotation controller 15b. The rotation of the rotation shaft of the rotation motor 52 rotates the rotation shaft 53 to which the roll body 560 is mounted. The rotation motor 52 converts, for example, electric energy supplied from a power supply (not illustrated) into mechanical energy for rotating the roll body 560. The rotation motor 52 is, for example, a stepping motor.

The rotation shaft 53 is a rotation shaft when the rotation motor 52 rotates the roll body 560. Therefore, the roll body 560 is fixed to the rotation shaft 53 such that the central axis 561 of the roll body 560 coincides with the central axis (not illustrated) of the rotation shaft 53. In the present embodiment, as shown in FIG. 12, the roll body 560 is clamped from both ends by the rotary mechanism 50b and set in the rotary mechanism 50b. Specifically, one end of the paper core 550 included in the roll body 560 is fitted and fixed to a rotation shaft 53A. In addition, the other end of the paper core 550 is fitted and fixed to a rotation shaft 53B. As a result, the roll body 560 is rotatably supported by the rotary mechanism 50b.

The rotation shaft 53A is rotatably fixed to a support part 55A so as to extend in the horizontal direction. The rotation shaft 53B is rotatably fixed to a support part 55B so as to extend in the horizontal direction. Hereinafter, the support part 55A and the support part 55B will be collectively referred to as support part 55 as appropriate. In addition, the rotation shaft 53A and the rotation shaft 53B are interlocked. That is, the rotation direction of the rotation shaft 53A and the rotation direction of the rotation shaft 53B are the same, and the rotation angle of the rotation shaft 53A and the rotation angle of the rotation shaft 53B are the same. The rotation motor 52 is provided for each of the rotation shaft 53A and the rotation shaft 53B. In addition, the rotation motor drive circuit 51 supplies the same drive signal to the rotation motor 52 provided for the rotation shaft 53A and the rotation motor 52 provided for the rotation shaft 53B, respectively. Note that the rotation shaft 53A and the rotation shaft 53B are collectively referred to as rotation shaft 53 as appropriate.

The rotary encoder 54 is a sensor that converts a mechanical displacement amount of rotation into an electric signal and processes the electric signal to detect a position, a speed, and the like. The rotary encoder 54 supplies a rotation angle signal indicating an angle at which the rotation shaft 53 has rotated to the rotation controller 15b.

A sensor 60b is a sensor that acquires data corresponding to the slack amount of the transfer sheet 500 unwound from the roll body 560 and slackened by its own weight. The sensor 60b may be any type of sensor as long as the sensor can acquire data corresponding to the slack amount. As the sensor 60b, a proximity sensor that detects whether or not an object exists nearby in a non-contact manner, a distance measuring sensor that measures the distance to the object, an image sensor that converts the intensity of light emitted from the object into an electric signal, and the like can be considered. In the present embodiment, the sensor 60b is a proximity sensor. Examples of the proximity sensor include a sensor that emits an ultrasonic wave or an electromagnetic wave and detects a reflected wave of the ultrasonic wave or the electromagnetic wave reflected on a surface of an object.

Next, main functions of the controller 10b will be described in detail. The controller 10b functionally includes an ejection controller 11b, a movement controller 12b, a heating controller 13b, a transport controller 14b, a rotation controller 15b, and a measuring unit 16b. Each of these functions is implemented by software, firmware, or a combination of software and firmware. The software and the firmware are described as programs and stored in the ROM or the storage 21. Then, the CPU executes the program stored in the ROM or the storage 21 to implement each of these functions.

The ejection controller 11b controls ejection of ink by the ejection head 31. The ejection controller 11b controls the ejection head 31 to cause the ejection head 31 to eject the ink. For example, the ejection controller 11b causes the ejection head 31 to eject the ink on the basis of the print control data. The print control data is data indicating the type of the ink to be ejected, the ejection amount of the ink, the movement amount of the ejection head 31, and the like. The print control data is generated on the basis of, for example, image data supplied from the control device 400. The image data, the print control data, and the like are stored in the storage 21, for example.

The movement controller 12b controls the movement of the ejection head 31. Specifically, the movement controller 12b controls the head moving mechanism 32 to move the ejection head 31 in the main scanning direction. For example, the movement controller 12b changes the position of the ejection head 31 in the main scanning direction every time the ejection head 31 completes the ejection of the ink.

The heating controller 13b controls heating of the transfer sheet 500 and the transfer sheet 510. Specifically, the heating controller 13b controls the heating mechanism 33 to heat the transfer sheet 500 and the transfer sheet 510. For example, the heating controller 13b controls the rear-heater 331 to heat the transfer sheet 500. The heating controller 13b controls the after-heater 332 to heat the transfer sheet 510.

The transport controller 14b controls transport of the transfer sheet 500. Specifically, the transport controller 14b controls the transport mechanism 40b to transport the transfer sheet 500 unwound from the roll body 560 toward the downstream of the transport path. For example, every time printing of an image at a specific position in the transport direction of the transfer sheet 500 is completed, the transport controller 14b rotates the transport roller 43 by a specified angle and transports the transfer sheet 500 in the transport direction by a specified distance.

The rotation controller 15b controls the rotation of the roll body 560. Specifically, the rotation controller 15b controls the rotary mechanism 50b to rotate the roll body 560 in a direction in which the transfer sheet 500 is unwound from the roll body 560. In addition, the rotation controller 15b controls the rotary mechanism 50b so as to maintain a state in which the transfer sheet 500 unwound from the roll body 560 is slackened by its own weight. The direction in which the transfer sheet 500 is unwound from the roll body 560 is a direction in which the transfer sheet 500 is sent out toward the platen 90b along the transport path, and is a clockwise direction in FIG. 13.

In the present embodiment, basically, the rotation controller 15b rotates the roll body 560 only in the direction in which the transfer sheet 500 is unwound from the roll body 560, and does not rotate the roll body 560 in the direction in which the transfer sheet 500 is wound by the roll body 560. The direction in which the transfer sheet 500 is wound around the roll body 560 is a direction in which the transfer sheet 500 is pulled back from the platen 90b along the transport path, and is a counterclockwise direction in FIG. 13. Hereinafter, a direction in which the transfer sheet 500 is unwound from the roll body 560 is appropriately referred to as positive direction, and a direction in which the transfer sheet 500 is wound around the roll body 560 is appropriately referred to as negative direction.

When the slack of the transfer sheet 500 is likely to be eliminated by the transport of the transfer sheet 500 by the transport mechanism 40b, the rotation controller 15b rotates the roll body 560 in the positive direction. That is, the rotation controller 15b rotates the roll body 560 in the positive direction when the slack amount measured by the measuring unit 16b described later is smaller than the reference amount. When the slack amount of the transfer sheet 500 is insufficient, the rotation controller 15b rotates the roll body 560 in the positive direction regardless of the transport state of the transfer sheet 500 by the transport mechanism 40b.

That is, when the transport mechanism 40b transports the transfer sheet 500 and the slack amount of the transfer sheet 500 slackened by its own weight is insufficient, the rotation controller 15b rotates the roll body 560 in the positive direction. When the transport mechanism 40b stops the transport of the transfer sheet 500 and the slack amount of the transfer sheet 500 is insufficient, the rotation controller 15b rotates the roll body 560 in the positive direction. On the other hand, when the slack amount of the transfer sheet 500 is sufficient, the rotation controller 15b does not rotate the roll body 560 regardless of the transport state of the transfer sheet 500 by the transport mechanism 40b.

The measuring unit 16b measures the slack amount of the transfer sheet 500 slackened by its own weight. For example, the measuring unit 16b obtains the slack amount of the transfer sheet 500 on the basis of the data acquired by the sensor 60b. The measuring unit 16b may not calculate a strict numerical value indicating the slack amount, and may obtain the slack amount to such an extent that it can be determined whether or not the slack amount is less than the reference amount. In the present embodiment, the distance from the central axis 561 of the roll body 560 to the lowermost point of the transfer sheet 500 slackened by its own weight is regarded as a distance corresponding to the slack amount of the transfer sheet 500. That is, in the present embodiment, the measuring unit 16b measures the distance as the slack amount of the transfer sheet 500. The method of calculating the slack amount by the measuring unit 16b is appropriately adjusted according to the type of the sensor 60b, the arrangement of the sensor 60b, the method of using the sensor 60b, and the like.

Next, a method in which the print device 100b prints an image on the transfer sheet 500 while transporting the transfer sheet 500 will be described with reference to FIGS. 12 and 13.

First, before performing printing, as illustrated in FIGS. 12 and 13, the operator sets the roll body 560 in which the transfer sheet 500 is wound in a roll shape around the paper core 550 in the rotary mechanism 50b included in the transport device 110. That is, the operator fits one end of the paper core 550 into the rotation shaft 53A, and fits the other end of the paper core 550 into the rotation shaft 53B. Thus, the rotary mechanism 50b rotatably supports the roll body 560.

Next, the operator pulls out the transfer sheet 500 from the roll body 560, and stretches the transfer sheet 500 along the transport path. Specifically, the operator stretches the transfer sheet 500 by passing it over the heated member 335, the platen 90b, and the heated member 336. Then, the operator operates the control device 400 to start printing by the print device 100b. Note that the print device 100b prints an image on a region on the platen 90b in the transfer sheet 500.

The print device 100b starts heating by the rear-heater 331 and the after-heater 332 prior to printing. The print device 100b rotates the transport roller 43 to transport the transfer sheet 500 heated by the rear-heater 331 in the transport direction. The print device 100b prints an image with the color ink for transfer on a region of the heated transfer sheet 500 disposed on the platen 90b.

Further, the print device 100b applies the white ink to a region of the transfer sheet 500 on which an image is printed with the color ink. The print device 100b rotates the transport roller 43 to transport the transfer sheet 510 coated with the white ink onto the heated member 336 included in the after-heater 332. The print device 100b supplies the transfer sheet 510 heated by the after-heater 332 to the powder applicator 200b.

Here, while the print device 100b prints an image on the transfer sheet 500, the transport device 110 controls the rotary mechanism 50b so as to maintain a state in which the transfer sheet 500 unwound from the roll body 560 is slackened by its own weight. That is, the transport device 110 allows the transfer sheet 500 to slacken below the roll body 560 so as not to apply excessive tension to the portion of the transfer sheet 500 from the roll body 560 to the transport roller 43. The following explains the reason why the transport device 110 slackens the transfer sheet 500.

First, the roll body 560 may be deformed in the process of transportation, packing, and the like. For example, in a part or the whole of the roll body 560 in the longitudinal direction, the cross-sectional shape of the roll body 560 may be deformed into an elliptical shape instead of a perfect circular shape.

For example, when the cross-sectional shape is a shape other than the perfect circular shape over the entire roll body 560, the path length, which is the length of the path until the transfer sheet 500 separates from the roll body 560 and reaches the transport roller 43, periodically changes with the rotation angle of the roll body 560. The tension applied to the portion of the transfer sheet 500 from the roll body 560 to the transport roller 43 also periodically changes with the rotation angle of the roll body 560. In this case, there is a possibility that the transport speed of the transfer sheet 500 on the platen 90b is not stable, or defects such as floating of the transfer sheet 500 on the platen 90b may occur.

Further, for example, when the cross-sectional shape of one end of the roll body 560 is different from the cross-sectional shape of the other end of the roll body 560, there is a difference between the path length from one end of the roll body 560 to one end of the transport roller 43 and the path length from the other end of the roll body 560 to the other end of the transport roller 43. Then, there is a difference between the tension applied to the portion of the transfer sheet 500 from one end of the roll body 560 to one end of the transport roller 43 and the tension applied to the portion of the transfer sheet 500 from the other end of the roll body 560 to the other end of the transport roller 43. In this case, problems such as skew on the platen 90b and floating of the transfer sheet 500 on the platen 90b may occur.

Further, as the process of stretching the transfer sheet 500 from the roll body 560 and printing on the transfer sheet 500 progresses, the diameter of the roll body 560 gradually decreases. When the diameter of the roll body 560 decreases, the path length also changes, and the tension applied to the portion of the transfer sheet 500 from the roll body 560 to the transport roller 43 also changes. In this case, for example, the amount of sliding between the transfer sheet 500 and the transport roller 43 may change, and the transport speed of the transfer sheet 500 on the platen 90b may change.

As described above, when the tension applied to the portion of the transfer sheet 500 from the roll body 560 to the transport roller 43 changes, there is a possibility that defects such as a variation in the transport speed, a change in the transport speed, skew, and floating of the transfer sheet 500 occur. Therefore, in the present embodiment, the transfer sheet 500 is unwound from the roll body 560, and the transfer sheet 500 unwound from the roll body 560 is slackened. According to such a configuration, the tension applied to the portion of the transfer sheet 500 from the roll body 560 to the transport roller 43 is about the weight of the slackened portion of the transfer sheet 500. That is, according to such a configuration, the tension applied to the portion of the transfer sheet 500 from the roll body 560 to the transport roller 43 can be made small and constant.

Next, a method in which the transport device 110 slackens the transfer sheet 500 will be described in detail with reference to FIGS. 14 and 15. FIG. 14 is a side view of the transport device 110 to which the roll body 560 having a perfectly circular cross-sectional shape is mounted. FIG. 15 shows a side view of the transport device 110 to which the roll body 560 having an elliptical cross-sectional shape is mounted.

As illustrated in FIG. 14, the print device 100b transports the transfer sheet 500 in the transport direction by rotating the transport roller 43 in a state where the transfer sheet 500 is clamped between the transport roller 43 and the pinch roller 45. At this time, as illustrated in FIG. 14, the transport device 110 rotates the roll body 560 so as to maintain a state in which the transfer sheet 500 is slackened below the roll body 560.

Specifically, the rotation controller 15b rotates the roll body 560 in the positive direction so as to maintain a state in which L1 corresponding to the slack amount of the transfer sheet 500 is equal to or greater than Lth corresponding to the reference amount of the slack amount. FIG. 14 illustrates a state in which L1 is temporarily smaller than Lth, and the roll body 560 rotates in the positive direction. L1 is a length from the central axis 561 of the roll body 560 to a point Pb which is the lowest point of the transfer sheet 500. Lth is a reference value of a length from the central axis 561 of the roll body 560 to the point Pb which is the lowest point of the transfer sheet 500.

The method for specifying the magnitude relationship between L1 and Lth can be appropriately adjusted. In the present embodiment, the magnitude relationship between L1 and Lth is specified on the basis of the detection result of the sensor 60b, which is a proximity sensor having strong directivity. First, when L1 is equal to or greater than Lth, the sensor 60b is disposed such that a slackened portion in the transfer sheet 500 is detected by the sensor 60b. That is, the sensor 60b is arranged such that the detection direction thereof is oriented horizontally with respect to the position where the distance from the central axis 561 is Lth, that is, the transfer sheet 500 slackened to the above position can be detected from the side thereof.

When the slack of the transfer sheet 500 extends downward from the sensor 60b and L1 is Lth or more, the sensor 60b outputs object detection data that is data indicating that an object has been detected. On the other hand, when the slack of the transfer sheet 500 remains above the sensor 60b and L1 is less than Lth, the sensor 60b outputs object non-detection data which is data indicating that no object has been detected.

When the sensor 60b outputs the object detection data, the measuring unit 16b determines that the slack amount of the transfer sheet 500 is larger than the reference amount. When the sensor 60b outputs the object non-detection data, the measuring unit 16b determines that the slack amount of the transfer sheet 500 is smaller than the reference amount. The rotation controller 15b does not rotate the roll body 560 when the measuring unit 16b determines that the slack amount of the transfer sheet 500 is greater than or equal to the reference amount. When the measuring unit 16b determines that the slack amount of the transfer sheet 500 is less than the reference amount, the rotation controller 15b rotates the roll body 560 in the positive direction to increase the slack amount of the transfer sheet 500.

The same applies to the operation of the transport device 110 when the roll body 560 having an elliptical cross-sectional shape is mounted on the transport device 110. That is, as illustrated in FIG. 15, the transport device 110 rotates the roll body 560 so as to maintain a state in which the transfer sheet 500 is slackened below the roll body 560. Specifically, the rotation controller 15b rotates the roll body 560 so as to maintain a state in which L1 corresponding to the slack amount of the transfer sheet 500 is equal to or greater than Lth corresponding to the reference amount of the slack amount. FIG. 15 illustrates a state in which L1 is temporarily smaller than Lth, and the roll body 560 rotates.

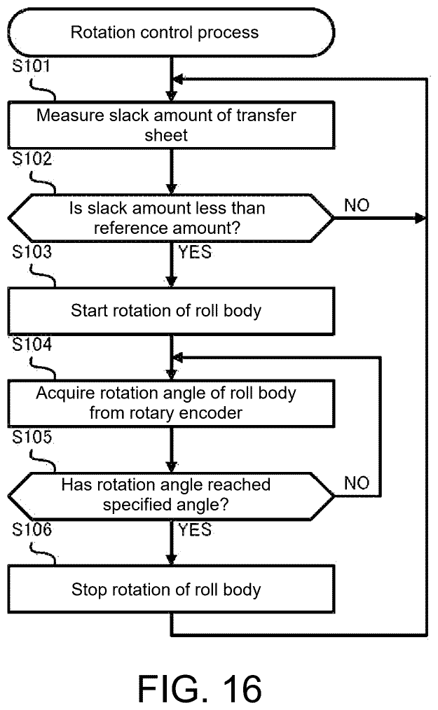

Next, a rotation control process executed by the transport device 110 will be described with reference to a flowchart illustrated in FIG. 16. The rotation control process is control for rotating the roll body 560 by control on the rotary mechanism 50b. Note that the rotation control process is executed independently of the transport control process in which the transport controller 14b controls the transport mechanism 40b to transport the transfer sheet 500 unwound from the roll body 560 toward the downstream side of the transport path. The transport method according to the present embodiment is realized by executing a transport control process and a rotation control process.

First, the controller 10b measures the slack amount of the transfer sheet 500 (step S101). Specifically, the controller 10b calculates the slack amount using the detection result of the sensor 60b. In the present embodiment, the controller 10b may measure the slack amount to such an extent that it can be determined whether the slack amount is less than the reference value. Upon completion of the process of step S101, the controller 10b determines whether or not the slack amount is less than the reference value (step S102).

When determining that the slack amount is not less than the reference value (step S102: NO), the controller 10b returns the process to step S101. On the other hand, when determining that the slack amount is less than the reference value (step S102: YES), the controller 10b starts the rotation of the roll body 560 (step S103). Specifically, the controller 10b controls the rotation motor drive circuit 51 to start the process of rotating the rotation shaft 53 in the direction in which the transfer sheet 500 is unwound from the roll body 560.

Upon completion of the process of step S103, the controller 10b acquires the rotation angle of the roll body 560 from the rotary encoder 54 (step S104). The rotation angle of the roll body 560 is the rotation angle of the rotation shaft 53, and is the angle at which the rotation shaft 53 has rotated from the start of rotation of the rotation shaft 53 to the current time. Upon completion of the process of step S104, the controller 10b determines whether the rotation angle has reached the specified angle (step S105). The specified angle is an angle at which the roll body 560 is rotated by one rotation control.

When determining that the rotation angle has not reached the specified angle (step S105: NO), the controller 10b returns the process to step S104. On the other hand, when determining that the rotation angle has reached the specified angle (step S105: YES), the controller 10b stops the rotation of the roll body 560 (step S106). That is, the controller 10b controls the rotation motor drive circuit 51 to terminate the process of rotating the rotation shaft 53 in the positive direction. Upon completion of the process of step S106, the controller 10b returns the process to step S101.

In the present embodiment, the rotary mechanism 50b is controlled so as to maintain the state in which the transfer sheet 500 unwound from the roll body 560 is slackened by its own weight. Therefore, in the present embodiment, the tension applied to the portion of the transfer sheet 500 from the roll body 560 to the transport roller 43 can be made small and constant. Therefore, according to the present embodiment, the transfer sheet 500 can be appropriately unwound from the roll body 560 and transported.

In the present embodiment, when the transport mechanism 40b transports the transfer sheet 500, the roll body 560 is rotatable in a direction in which the transfer sheet 500 is unwound from the roll body 560. That is, in the present embodiment, since the transfer sheet 500 can be unwound while being transported, scanning can be executed while unwinding is executed. As described above, in the present embodiment, it is not necessary to stop the transport of the transfer sheet 500 for the rotation of the roll body 560. Therefore, according to the present embodiment, it is possible to appropriately unwind and transport the transfer sheet 500 from the roll body 560 while suppressing a decrease in the processing speed.

In the present embodiment, when the measured slack amount is smaller than the reference amount, the roll body 560 rotates in a direction in which the transfer sheet 500 is unwound from the roll body 560. Therefore, according to the present embodiment, the transfer sheet 500 is suppressed from being excessively unwound from the roll body 560.

In the present embodiment, the medium to be unwound and transported is the transfer sheet 500 including the receiving layer 503, the peeling layer 502, and the film layer 501. In the transfer sheet 500, defects such as variations in transport speed, variations in transport speed, skew, and floating of the transfer sheet 500 may easily occur due to changes in tension, variations in tension, and the like. According to the present embodiment, it can be expected that such a defect is suppressed at the time of printing the transfer sheet 500.

### Another Embodiment 2

In Another embodiment 1, an example in which the slack amount of the transfer sheet 500 is measured using the sensor 60b which is a proximity sensor has been described. The method of measuring the slack amount of the transfer sheet 500 can be appropriately adjusted. In the present embodiment, an example in which the slack amount of the transfer sheet 500 is measured using a sensor 61b which is a distance measuring sensor will be described with reference to FIG. 17. Hereinafter, description of configurations and functions similar to those of Another embodiment 1 will be omitted or simplified as appropriate.

As illustrated in FIG. 17, a transport device 111 according to the present embodiment includes the sensor 61b instead of the sensor 60b. The sensor 61b is a sensor that acquires data corresponding to the slack amount of the transfer sheet 500 unwound from the roll body 560 and slackened by its own weight. The sensor 61b is a distance measuring sensor that measures a distance to an object. The sensor 61b may be an ultrasonic sensor or a laser sensor. The ultrasonic sensor is a sensor that measures a distance from the sensor 61b to an object on the basis of a time from emission of an ultrasonic wave to detection of a reflected wave of the ultrasonic wave reflected on a surface of the object. The laser sensor is a sensor that measures a distance from the sensor 61b to an object on the basis of a time from emission of a laser to detection of a reflected wave of the laser reflected on a surface of the object.

In the present embodiment, the sensor 61b is disposed so that the height of the point Pb, which is the lowest point of the transfer sheet 500, can be measured. That is, the sensor 61b is disposed below the point Pb such that the detection direction of the sensor 61b faces upward. The sensor 61b measures L2 which is a distance from the sensor 61b to the point Pb. Here, the sum of L1 and L2 corresponding to the slack amount is L0, which is the distance from the central axis 561 to the sensor 61b, and is a constant value.

The measuring unit 16b calculates L1 corresponding to the slack amount by subtracting L2 measured by the sensor 61b from L0. The rotation controller 15b does not rotate the roll body 560 when L1 calculated by the measuring unit 16b is greater than or equal to Lth corresponding to the reference amount of the slack amount. When L1 calculated by the measuring unit 16b is less than Lth corresponding to the reference amount of the slack amount, the rotation controller 15b rotates the roll body 560 in the positive direction to increase the slack amount of the transfer sheet 500.

In the present embodiment, the slack amount of the transfer sheet 500 is measured using the sensor 61b which is a distance measuring sensor. Therefore, according to the present embodiment, since the slack amount is accurately measured, the slack amount of the transfer sheet 500 can be maintained at an appropriate amount of slack.

### Modified Example

Although the embodiments have been described above, modifications and applications according to various forms are possible. The adoption of any of the configurations, functions, and operations described in the foregoing embodiment is optional. Further, in addition to the configurations, functions, and operations described above, additional configurations, functions, and operations may also be adopted. Furthermore, any combination of the configurations, functions, and operations described in the foregoing embodiment may be adopted as desired.

In Another embodiment 1, an example has been described in which the rotation controller 15b rotates the roll body 560 in the positive direction by the specified angle when the slack amount is less than the reference amount. When the slack amount is less than the reference amount, the rotation controller 15b may rotate the roll body 560 in the positive direction until the slack amount becomes greater than or equal to the reference amount.

In Another embodiment 1, an example has been described in which the rotation shaft 53 is separated into two, the rotation shaft 53A and the rotation shaft 53B. The rotation shaft 53 may be one shaft passing through the paper core 550 of the roll body 560.

In Another embodiment 1, the sensor 60b, which is a proximity sensor, is used to measure the slack amount, and in Another embodiment 2, the sensor 61b, which is a distance measuring sensor, is used to measure the slack amount. The sensor used for measuring the slack amount is not limited to these examples. For example, an image sensor that converts the intensity of light emitted from an object into an electric signal may be used to measure the slack amount. In this case, the measuring unit 16b may specify the position of the point Pb that is the lowest point of the transfer sheet 500 on the image on the basis of the electric signal output from the image sensor, and obtain the slack amount from the specified position of the point Pb.

In Another embodiment 1, an example has been described in which the medium to be unwound and transported is the transfer sheet 500 including the receiving layer 503, the peeling layer 502, and the film layer 501. The medium to be unwound and transported is not limited to the transfer sheet 500. The medium to be unwound and transported may be a general print medium such as paper or a film. The medium to be unwound and transported may be a medium to be processed other than printing.

In Another embodiment 1, in the controller 10b, the CPU functions as each unit illustrated in FIG. 11 by executing a program stored in the ROM or the storage 21. However, in the present disclosure, the controller 10b may be dedicated hardware. The dedicated hardware is, for example, a single circuit, a composite circuit, a programmed processor, an application specific integrated circuit (ASIC), a field-programmable gate array (FPGA), or a combination thereof. In a case where the controller 10b is dedicated hardware, the functions of the respective units may be realized by individual hardware, or the functions of the respective units may be collectively realized by a single hardware. In addition, some of the functions of the respective units may be implemented by dedicated hardware, and other functions may be implemented by software or firmware. As described above, the controller 10b can implement the above-described functions by hardware, software, firmware, or a combination thereof.

By applying an operation program that defines the operation of the print device 100b according to the present disclosure to an existing computer such as a personal computer or an information terminal device, the computer can be caused to function as the print device 100b according to the present disclosure. Furthermore, a distribution method of such a program is optional, and for example, the program may be stored and distributed in a computer-readable recording medium such as a compact disk ROM (CD-ROM), a digital versatile disk (DVD), a magneto optical disk (MO), or a memory card, or may be distributed via a communication network such as the Internet.

The present disclosure enables various embodiments and modifications without departing from the broad spirit and scope of the present disclosure. In addition, the above-described embodiment is for describing the present disclosure, and do not limit the scope of the present disclosure. That is, the scope of the present disclosure is indicated by the claims rather than the embodiment. Various modifications made within the scope of the claims and within the meaning of the equivalent disclosure are deemed to be within the scope of the present disclosure.

### REFERENCE SIGNS LIST

10 Controller
11 Data generator
12 Viscosity controller
13 Ejection controller
14 Movement controller
15 Transport controller
16 Heating controller
21 Storage
22 Display unit
23 Operation receiving unit
24 Communication unit
30 Viscosity adjustment mechanism
40 Ejection head
50 Head moving mechanism
60 Sheet transport mechanism
61 Transport roller
62, 62A Pinch roller
63 Roller support part
64 Motor
65 Sheet clamping unit
70 Heating mechanism
71 Rear-heater
72 After-heater
80 Roll holder
81,83 Protrusion
82,84 Support part
90 Platen
100 Print device
200 Powder applicator
300 Transfer device
400 Control device
500, 510, 520 Transfer sheet
501 Film layer
502 Peeling layer
503 Receiving layer
503A, 503B, 503C region
504 Ink layer
505 Powder layer
600 Fabric
610 Printed fabric
711, 721 Heater
712,722 Heated member
1000 Print system
11b Ejection controller
12b Movement controller
13b Heating controller
14b Transport controller
15b Rotation controller
16b Measuring unit
31 Ejection head
32 Head moving mechanism
33 Heating mechanism
40b Transport mechanism
41 Transport motor drive circuit
42 Transport motor
43 Transport roller
44,54 Rotary encoder
50 Rotary mechanism
51 Rotation motor drive circuit
52 Rotation motor
53, 53A, 53B Rotation shaft
55, 55A, 55B Support part
60b,61b Sensor
100b Print device
110, 111 Transport device
331 Rear-heater
332 After-heater
333, 334 Heater
335, 336 Heated member
550 Paper core
560 Roll body
561 Central axis
1000b Print system

1. A print device that prints an image with transfer ink on a transfer sheet including a receiving layer that receives the transfer ink, a peeling layer that joins the receiving layer and a film layer in a peelable manner, and the film layer that supports the receiving layer via the peeling layer, the print device comprising:
a transport roller that rotates in contact with the film layer of the transfer sheet;
a pinch roller that clamps the transfer sheet together with the transport roller, and rotates in contact with the receiving layer of the transfer sheet; and
a printing unit that prints an image with the transfer ink on the transfer sheet transported by the transport roller and the pinch roller; wherein
a portion of the pinch roller that contacts the receiving layer is formed of a low-adhesion material that is less likely to adhere to the receiving layer than to the peeling layer is.

2. The print device set forth in claim 1, wherein
the low-adhesion material is at least one selected from a fluorine-containing compound, a silicon-containing compound, and an oil-containing polyoxymethylene (POM).

3. The print device set forth in claim 1, wherein
the printing unit includes an inkjet head.

4. A transport device that transports a transfer sheet including a receiving layer that receives transfer ink, a peeling layer that joins the receiving layer and a film layer in a peelable manner, and the film layer that supports the receiving layer via the peeling layer, the transport device comprising:
a transport roller that rotates in contact with the film layer of the transfer sheet; and
a pinch roller that clamps the transfer sheet together with the transport roller, and rotates in contact with the receiving layer of the transfer sheet; wherein
a portion of the pinch roller that contacts the receiving layer is formed of a low-adhesion material that is less likely to adhere to the receiving layer than the peeling layer is.

5. A pinch roller that is used for a transport device that transports a transfer sheet including a receiving layer that receives transfer ink, a peeling layer that joins the receiving layer and a film layer in a peelable manner, and the film layer that supports the receiving layer via the peeling layer, the pinch roller comprising,
clamping the transfer sheet together with the transport roller, and rotating in contact with the receiving layer of the transfer sheet, wherein
a portion that contacts the receiving layer is formed of a low-adhesion material that is less likely to adhere to the receiving layer than the peeling layer is.

6. A print system that executes transfer printing using a transfer sheet including a receiving layer that receives transfer ink, a peeling layer that joins the receiving layer and a film layer in a peelable manner, and the film layer that supports the receiving layer via the peeling layer, the print system comprising:
a print device that prints an image with the transfer ink on the transfer sheet;
a powder applicator that applies an adhesive powder to the transfer sheet on which the image is printed by the print device; and
a transfer device that transfers the image drawn on the transfer sheet to which the adhesive powder is applied by the powder applicator onto a transfer target medium; wherein
the print device includes
a transport roller that rotates in contact with the film layer of the transfer sheet, and
a pinch roller that clamps the transfer sheet together with the transport roller, and rotates in contact with the receiving layer of the transfer sheet, and
a portion of the pinch roller that contacts the receiving layer is formed of a low-adhesion material that is less likely to adhere to the receiving layer than the peeling layer is.

7. A transport device comprising:
a rotary mechanism configured to support a roll body around which a medium is wound in a roll shape such that a central axis of the roll body is horizontal, and rotate the roll body about the central axis;
a controller that controls the rotary mechanism to rotate the roll body in a direction in which the medium is unwound from the roll body; and
a transport mechanism configured to transport the medium unwound from the roll body toward a downstream side of a transport path, wherein
the controller controls the rotary mechanism so as to maintain a state in which the medium unwound from roll body is slackened by its own weight.

8. The transport device set forth in claim 7, wherein
the controller rotates the roll body in a direction in which the medium is unwound from the roll body during transport of the medium by the transport mechanism.

9. The transport device set forth in claim 7, comprising a measuring unit that measures a slack amount of the medium slackened by its own weight, wherein
the controller rotates the roll body in a direction in which the medium is unwound from the roll body when the slack amount measured by the measuring unit is smaller than a reference amount.

10. The transport device set forth in claim 7, wherein
the medium is a transfer sheet including a receiving layer that receives transfer ink, a peeling layer that joins the receiving layer and a film layer in a peelable manner, and the film layer that supports the receiving layer via the peeling layer.

11. A print device comprising:
the transport device set forth in claim 7, and
an ejection head that ejects ink onto the medium transported by the transport device.

12. A transport method comprising:
supporting a roll body around which a medium is wound in a roll shape such that a central axis of the roll body is horizontal;
rotating the roll body about the central axis in a direction in which the medium is unwound from the roll body;
transporting the medium unwound from the roll body toward a downstream side of a transport path; and
rotating the roll body so as to maintain a state in which the medium unwound from the roll body is slackened by its own weight.
